(19) United States
(12) Patent Application Publication
(10) Pub. No.: US 2025/0353493 A1
(43) Pub. Date: Nov. 20, 2025

(54) VEHICLE MONITORING APPARATUS, VEHICLE COMPRISING SAME AND VEHICLE OPERATING METHOD

(71) Applicant: LG ELECTRONICS INC., Seoul (KR)

(72) Inventors: Jaehoon CHO, Seoul (KR); Sungil CHO, Seoul (KR); Eunju LEE, Seoul (KR); Sunghwan CHOI, Seoul (KR)

(73) Assignee: LG ELECTRONICS INC., Seoul (KR)

(21) Appl. No.: 18/868,423

(22) PCT Filed: May 23, 2022
(86) PCT No.: PCT/KR2022/007298

§ 371 Date: Nov. 22, 2024

(51) Int. Cl. B60W 30/095; B60Q 9/00; B60W 50/14; B60W 60/00; G06V 20/58; G06V 20/59; G06V 40/20; G10K 11/178

(52) U.S. Cl. CPC B60W 30/0956; B60Q 9/008; B60W 50/14; B60W 60/0051; G06V 20/58; G06V 20/597; G06V 40/20; G10K 11/17823; G10K 11/17873; B60W 2050/143; B60W 2050/146; B60W 2420/403; G10K 2210/1282; G10K 2210/3027

(57) ABSTRACT

A vehicle monitoring apparatus, a vehicle comprising same and a vehicle operating method are disclosed. The vehicle monitoring apparatus according to the present invention can operate, on the basis of a user input received in a parked/stopped state of a vehicle, an internal air conditioning system of the vehicle and an internal sensor for monitoring the state of a driver. If it is determined from the monitoring results of the internal sensor that the driver is sleeping, an active noise cancellation function is activated in order to remove sleep disturbance and an external sensor for monitoring vehicle-adjacent objects can be additionally operated. Moreover, if it is determined from the monitoring results of the internal sensor that the driver is absent, only the external sensor can be additionally operated for security.

### TECHNICAL FIELD

The present disclosure relates to a vehicle monitoring device, a vehicle including the vehicle monitoring device, and a method of operating the vehicle. More particularly, the present disclosure relates to a vehicle monitoring device, a vehicle including the vehicle monitoring device, and a method of operating the vehicle, all of which are capable of simultaneously performing in-vehicle environment adjustment and outside-vehicle environment monitoring on the basis of a state of a vehicle occupant monitored in a state where a vehicle is parked or stopped.

### BACKGROUND ART

For safety and convenience of a user who uses a vehicle, various sensors and devices are provided in the vehicle, and the vehicle's functions are expanded. The vehicle's functions may include a convenience function for enhancing the driver's convenience, and a safety function for enhancing the safety of the driver and/or pedestrian.

In recent years, with an increasing demand for travel, camping, vehicle camping, and similar activities that involve the use of vehicles, the amount of time occupants spend inside their vehicles has significantly increased. Vehicles are now utilized for various purposes beyond just transportation. For example, in some cases, occupants stay or fall asleep for a long time inside their occupants for the purpose of camping or vehicle camping.

Accordingly, in the related art, technologies have been developed that focus on functions to prevent sleep-related accidents involving occupants inside their vehicles. Furthermore, in recent years, technologies have been actively developed to maintain pleasant internal environments in vehicles while occupants fall asleep inside. In this regard, the camp mode available in Tesla vehicles provides functions, such as vehicle temperature adjustment and air conditioning, for occupants to create a camping-like atmosphere.

In a state where a vehicle is stopped, if an occupant inside the vehicle falls asleep or temporarily moves away from the vehicle, it is necessary to monitor whether or not a dangerous situation occurs in the vicinity of the vehicle.

For example, in a case where an occupant falls asleep inside the vehicle, it is necessary to continuously monitor an external danger to ensure the occupant's safety while maintaining a pleasant internal environment in the vehicle. In addition, for example, in a case where an occupant moves away from the vehicle to enjoy leisure activities, such as playing in the water near the vehicle. It is necessary to ensure the vehicle's safety by periodically monitoring its surroundings, even if the user is nearby.

In this regard, the Sentry Mode available in Tesla vehicles has a function of monitoring the surroundings of the vehicle using a plurality of cameras mounted on the exterior of the vehicle. However, in a case where the vehicle key is placed near the vehicle, the monitoring function in the Sentry Mode determines that there is no need to monitor a dangerous situation and therefore does not operate. For example, in a case where the camping mode is executed with the vehicle key inside the vehicle, the monitoring function in the Sentry Mode does not operate when an occupant is present inside the vehicle or when a driver carrying the vehicle key is near the vehicle, That is, the Sentry Mode provides only a function for protecting the vehicle in a situation where the owner of the vehicle moves away from the vehicle.

In addition, U.S. Pat. No. 11,010,594 discloses a technology that, if an object approaches a vehicle, controls the opening and closing of the vehicle when this object is the driver, and displays an image indicating the emotional state of the driver inside the vehicle on the exterior of the vehicle when this object is not the driver. However, this technology focuses on aesthetic sensibility without regard to vehicle protection and does not provide sufficient individualized responses corresponding to various objects that may approach the vehicle. In addition, this technology does not contribute to the vehicle occupant's safety either.

### DISCLOSURE OF INVENTION

### Technical Problem

Objects of the present disclosure are to address the above-mentioned problems and other problems.

One object of one or several embodiments of the present disclosure is to provide a vehicle monitoring device, a vehicle including the vehicle monitoring device, and a method of operating the vehicle, all of which are capable of monitoring a dangerous object in the vicinity of the vehicle even while the key and an occupant of the vehicle are present inside the vehicle.

Another object of one or several embodiments of the present disclosure is to provide a vehicle monitoring device, a vehicle including the vehicle monitoring device, and a method of operating the vehicle, all of which are capable of providing an alert by monitoring a dangerous object in the vicinity of the vehicle even when a user carrying the vehicle key is present in the vicinity of the vehicle in a situation where the vehicle's air-conditioning system or a similar system operates while the vehicle is parked or stopped.

Still another object of one or several embodiments of the present disclosure is to provide a vehicle monitoring device, a vehicle including the vehicle monitoring device, and a method of operating the vehicle, all of which are capable of maintaining a pleasant environment inside the vehicle and providing a variable warning alert for a dangerous object in the vicinity of the vehicle according to the state of an occupant of the vehicle by monitoring the state of the vehicle occupant in a state where the vehicle is parked or stopped.

Yet another object of one or several embodiments of the present disclosure is to provide a vehicle monitoring device, a vehicle including the vehicle monitoring device, all of which are capable of providing an alert and performing an operation in a differentiated and variable manner to protect the vehicle and/or an occupant of the vehicle according to the type of object in the vicinity of the vehicle that approaches the vehicle and a change in behavioral characteristic of the object in a state where the vehicle is parked or stopped.

### Solution to Problem

To accomplish these objects, a vehicle monitoring device according to the present disclosure can operate an internal air-conditioning system and an internal sensor for monitoring a state of an occupant on the basis of a user input received in a state where a vehicle is parked or stopped. When it is determined as a result of monitoring by the internal sensor that the occupant is in a sleeping state, an adaptive noise cancellation function and an external sensor for monitoring an object in the vicinity of the vehicle can be additionally operated. When it is determined as a result of monitoring by the internal sensor that the occupant is absent, only the external sensor can be operated.

When it is determined as a result of monitoring by the external sensor that the object approaches the vehicle, the adaptive noise cancellation function can be deactivated, and a suitable intervention alert associated with the movement of the object can be output. The intervention alert can vary according to the movement of the object and the result of tracking the extent to which the object approaches the vehicle. The intervention alert may include an operation of transmitting an external alert and/or initiating an autonomous traveling mode of the vehicle.

According to one aspect of an embodiment of the present disclosure, there is provided a vehicle including: a first sensor that is provided inside the vehicle and monitors a state of a vehicle occupant; a second sensor that is provided on the exterior of the vehicle and monitors the movement of an object in the vicinity of the vehicle; a noise control module that controls the operation of an adaptive noise cancellation (ANC) function equipped in the vehicle; output modules that are provided inside the vehicle and on the exterior of the vehicle, respectively; and a processor that executes a first operational mode for activating an internal air-conditioning system of the vehicle and the first sensor on the basis of a received user input in a state where the vehicle is parked or stopped, and that, in the first operational mode, on the basis of the result of the monitoring by the first sensor, additionally executes a second operational mode for activating the adaptive noise cancellation (ANC) function and the second sensor. In the vehicle, the processor determines on the basis of the monitoring by the second sensor that the object in the vicinity of the vehicle approaches the vehicle, and controls the noise control module and the output modules on the basis of the determination in such a manner as to deactivate the adaptive noise cancellation (ANC) function and to output an intervention alert associated with the movement of the object.

In an embodiment, in the vehicle, in the first operational mode, the processor may execute the second operational mode by activating both the ANC function and the second sensor when it is determined as a result of monitoring by the first sensor that an occupant is in a sleeping state, and may execute the second operational mode by activating the second sensor when it is determined as a result of monitoring by the first sensor that the occupant is in an absent state for a predetermined time.

In an embodiment, in the vehicle, the first sensor may be an internal camera of the vehicle, and the processor may recognize the occupant from images collected through the internal camera using a pre-trained model operating in conjunction with the processor, and may determine whether or not the occupant is in the sleeping state by detecting the movement of joint points of the recognized occupant.

In an embodiment, in the vehicle, the processor may control the output modules in such a manner that the intervention alert is output through a first output module provided inside the vehicle when the occupant is in the sleeping state, and that the intervention alert is output through a second output module provided on the exterior of the vehicle when the occupant is in the absent state.

In an embodiment, in the vehicle, the second sensor may include an external camera and a Far Infrared (FAR) sensor of the vehicle, and, when the second operational mode starts, the processor may perform labeling on images collected through the external camera and the Far Infrared (FAR) sensor, may compute the density of the objects from the labeled images, and may determine a risk level of the vicinity of the vehicle on the basis of the computed density of the objects and risk-level history information for the current location of the vehicle.

In an embodiment, in the vehicle, the processor may set an intervention policy corresponding to the intervention alert on the basis of the risk level of the vicinity of the vehicle, and the intervention policy may be set in a manner that varies according to the time information, the location information, the type of the object, and the behavioral category of the object.

In an embodiment, in the vehicle, the risk level of the vicinity of the vehicle and the intervention policy may be updated at a predetermined period while the second operational mode is executed.

In an embodiment, in the vehicle, the processor may output the intervention alert associated with the movement of the object while gradually increasing a risk situation level according to the extent to which the object approaches the vehicle.

In an embodiment, in the vehicle, in response to the object approaching the vehicle within a first reference distance range, the processor may output information associated with the object by operating at least one of the following: a display and an audio output part, which are provided in the vehicle, and, in response to the object approaching the vehicle within a second reference distance range shorter than the first reference distance range, the processor may output the intervention alert by operating at least one of the following: the audio output part, the display, or a lamp, each of which is provided on the exterior of the vehicle.

In an embodiment, in the vehicle, information associated with the object may include an image including the object and intervention guide information related to the object.

In an embodiment, in the vehicle, when the object approaches the vehicle within the second reference distance range and then satisfies a preset condition, the processor may generate a control signal for executing a vehicle locking mode and switching to an autonomous traveling mode.

In an embodiment, in the vehicle, while the second operational mode is executed, the processor may control the output modules in such a manner that the direction of sound collected through a microphone provided on the exterior of the vehicle is tracked, that a 3D view of an image, including the object in the vicinity of the vehicle, which is collected by the second sensor, is generated on the basis of the tracking, and that the image from the generated 3D view is output, as the intervention alert, on a display inside the vehicle.

In an embodiment, in the vehicle, the image from the 3D view includes annotation information for each recognized object and an identification display for the object that approaches the vehicle.

In an embodiment, in the vehicle, in response to receiving input on a specific object or the annotation information, each of which is included in the image from the 3D view, which is output on the display, the processor may control the operation of the second sensor and the operation of the output modules associated with the operation of the second sensor in such a manner as to track the risk sensitivity to the corresponding object.

In an embodiment, in the vehicle, when it is detected by the second sensor that the corresponding object moves away from the vehicle and a predetermined time has elapsed, the processor may control the noise control module on the basis of the monitoring by the first sensor in such a manner that the ANC function is reactivated.

According to another aspect of the embodiment of the present disclosure, there is provided a method of operating a vehicle, the method including the following steps. The method includes a step of receiving a preset user input in a state where the vehicle is parked or stopped; a step of executing a first operational mode for activating an internal air-conditioning system of the vehicle and a first sensor, which monitors a state of a vehicle occupant, on the basis of the received user input; a step of additionally executing a second operational mode for activating an adaptive noises cancellation (ANC) function equipped in the vehicle and a second sensor that monitors the movement of an object in the vicinity of the vehicle, on the basis of the monitoring by the first sensor; a step of determining on the basis of the monitoring by the second sensor that the object in the vicinity of the vehicle approaches the vehicle; and a step of deactivating the adaptive noise cancellation (ANC) function and outputting an intervention alert associated with the movement of the object, on the basis of the determination.

In an embodiment, the method may further include, after the step of executing the first operational mode, a step of executing the second operational mode by activating both the ANC function and the second sensor when it is determined as a result of monitoring by the first sensor that the occupant is in a sleeping state, and activating the second sensor when it is determined as a result of monitoring by the first sensor that the occupant is in an absent state for a predetermined time.

In an embodiment, in the method, the step of outputting the intervention alert may be a step of outputting the intervention alert through a first output module provided inside the vehicle when the occupant is in the sleeping state, and outputting the intervention alert through a second output module provided on the exterior of the vehicle when the occupant is in the absent state.

In an embodiment, in the method, the step of outputting the intervention alert may be a step of outputting the intervention alert associated with the movement of the object while gradually increasing a risk situation level according to the extent to which the object in the vicinity of the vehicle approaches the vehicle.

According to still another aspect of the embodiment of the present disclosure, there is provided a vehicle monitoring device including: an interface unit that performs communication with at least one of the components provided in a vehicle; and a processor that, in a state where the vehicle is parked or stopped, in response to reception of a signal corresponding to a preset user input, generates a first control signal for activating an internal air-conditioning system of the vehicle and a first sensor, which monitors a state of a vehicle occupant, and transmits the generated first control signal to the vehicle through the interface unit. In the vehicle monitoring device, the processor generates a second control signal for receiving the result of the monitoring by the first sensor, additionally activating an adaptive noise cancellation (ANC) function equipped in the vehicle and a second sensor for monitoring the movement of an object in the vicinity of the vehicle, on the basis of the received result, and transmits the generated second control signal to the vehicle through the interface unit. In the vehicle monitoring device, the processor transmits a third control signal for receiving the result of the monitoring by the second sensor, determining on the basis of the received result that the object approaches the vehicle, deactivating the active noise cancellation (ANC) function on the basis of the determination, and outputting an intervention alert associated with the movement of the object, to the vehicle through the interface unit.

### Advantageous Effects of Invention

Advantageous effects of a vehicle monitoring device according to the present disclosure, a vehicle including the vehicle monitoring device, and a method of operating the vehicle are described as follows.

According to one or several embodiments of the present disclosure, in a state where the vehicle is parked or stopped, an object in the vicinity of the vehicle can be continuously monitored while maintaining the operations of a vehicular air-conditioning system and an ANC function. Accordingly, a pleasant in-vehicle environment can be provided to the occupant of the vehicle, and the vehicle can be securely protected from an external brake-in.

In addition, an optimal adaptive warning alarm and intervention can be provided, taking into account all of the following: the types of objects in the vicinity of the vehicle, the behavioral characteristic of the object, the change in the behavior of the object, and the state or location of the vehicle occupant/the vehicle owner.

For example, as a result of monitoring the object in the vicinity of the vehicle, the vehicle occupant can listen to external sound by deactivating the ANC function. In addition, for example, a differentiated alarm can be provided according to the extent to which a dangerous object approaches the vehicle. Based on the state or location of the occupant/the vehicle owner, warning alarms at stepwise levels can be provided, or a warning output unit can be selectively used. In addition, for example, in a state where the door of the vehicle is open or in a situation where the vehicle owner is present in the vicinity of the vehicle, but does not pay attention to the vehicle, the vehicle can still be securely protected from external risks.

### BRIEF DESCRIPTION OF DRAWINGS

FIG. 1 is a view illustrating an example of a vehicle in accordance with an embodiment of the present disclosure.

FIG. 2 is a set of views illustrating the vehicle in accordance with the embodiment of the present disclosure from various angles.

FIGS. 3 and 4 are views each illustrating the interior of the vehicle in accordance with the embodiment of the present disclosure.

FIGS. 5 and 6 are views that are referenced to describe various objects associated with the traveling of the vehicle in accordance with the embodiment of the present disclosure.

FIG. 7 is a block diagram that is referenced to describe the vehicle in accordance with the embodiment of the present disclosure.

FIG. 8 is a view that is referenced to describe the active noise cancellation (ANC) function of the vehicle in accordance with the embodiment of the present disclosure.

FIG. 9 is a block diagram that is referenced to describe the monitoring of the vehicle's interior and surroundings, UI information display, and situational-based vehicle control, all of which are in accordance with an embodiment of the present disclosure.

FIG. 10 is a representative flowchart that is referenced to describe a method of operating the vehicle in accordance with the embodiment of the present disclosure.

FIG. 11 is a block diagram illustrating an exemplary configuration of a vehicle monitoring device in accordance with an embodiment of the present disclosure.

FIGS. 12 and 13 are views that are referenced to describe a method of monitoring a state of a vehicle occupant in the vehicle in accordance with the embodiment of the present disclosure.

FIG. 14 is a flowchart that is referenced to describe a method of determining the risk level of the vicinity of the vehicle on the basis of an object in the vicinity of the vehicle in accordance with the embodiment of the present disclosure.

FIGS. 15 and 16 are views that are referenced to describe a process for displaying the result of monitoring the movement of the object in the vicinity of the vehicle on a UI screen in the vehicle in association with the embodiment of the present disclosure.

FIGS. 17 to 19 are views illustrating how a situation-based warning alert is output and/or autonomous-traveling control is performed on the basis of the monitoring of the movement of the object in the vicinity of the vehicle in accordance with the embodiment of the present disclosure.

### MODE FOR THE INVENTION

Embodiments disclosed in the present specification will be described in detail below with reference to the accompanying drawings, and regardless of figure numbers, the same or similar constituent elements are given the same reference number and descriptions thereof are not repeated. The terms ‘module’ and ‘unit’ are hereinafter interchangeably or individually used to refer to a constituent element only for convenience in description in the present specification and therefore are not themselves intended to take on different meanings or to depict different functions. In addition, when describing the embodiments disclosed in the present specification, a detailed description of a related well-known technology will be omitted if it is determined that it would obscure the nature and gist of the present disclosure. In addition, when describing the embodiments disclosed in the present specification, a detailed description of a related well-known technology will be omitted if it is determined that it would obscure the nature and gist of the present disclosure. In addition, the accompanying drawings are provided only to help easily understand the embodiments disclosed in the present specification. It should be understood that the technical idea disclosed in the present specification is not limited by the accompanying drawings. Furthermore, it should be understood that any alteration or equivalent of, or any substitute for, a constituent element in accordance with the embodiment of the present disclosure, which falls within the scope of the technical idea of the present disclosure, is included within the scope of the present disclosure.

The ordinal numbers first, second, and so forth may be used to describe various elements, but they do not limit these elements. These ordinal numbers are only used to distinguish one element from another.

It should be understood that a constituent element, when referred to as ‘connected to’ or ‘have access to’ a different constituent element, may be directly connected to or have direct access to the different constituent element or may be connected to or have access to the different constituent element, with a third constituent element in between. Likewise, it should be understood that a constituent element, when referred to as ‘directly connected to’ or ‘have direct access to’ a different constituent element, may be connected to or have access to the different constituent element without a third constituent element in between.

A noun in singular form has the same meaning as when used in its plural form, unless it has a different meaning in context.

The terms ‘include,’ ‘have,’ and the like, which are used in the present application, should be understood as indicating the presence of a feature, number, step, operation, constituent element, component, or combination thereof, without precluding the possibility of the presence or addition of one or more features, numbers, steps, operations, constituent constituents, components, or combinations thereof.

Examples of the vehicle described in the present specification may conceptually include all vehicles, such as internal combustion engine vehicles having an engine as a power source, hybrid vehicles having an engine and an electric motor as power sources, and electric vehicles having an electric motor as a power source. However, it should be noted that, hereinafter, the description of technologies that operate in a state where the vehicle is parked or stopped applies to electric vehicles and hybrid vehicles that primarily use electric motors.

In the following description, the left side of the vehicle refers to the left side in the traveling direction of the vehicle, and the right side of the vehicle refers to the right side in the traveling direction.

A ‘system’ disclosed in the present specification may include an external single server and a cloud apparatus/system with which a vehicle and/or one or more devices embedded in the vehicle communicate, but is not limited thereto. For example, the system may be configured with one or more server devices. As another example, the system may be configured with one or more cloud devices. As still another example, the system may be configured with both the server device and the cloud device, allowing it to operate.

In the present specification, a ‘user terminal’ or a ‘user client’ may refer to a computing apparatus, a system, or the user themselves that communicates with a vehicle (or a vehicular electronic component, a device, or a system, each of which is provided in the vehicle).

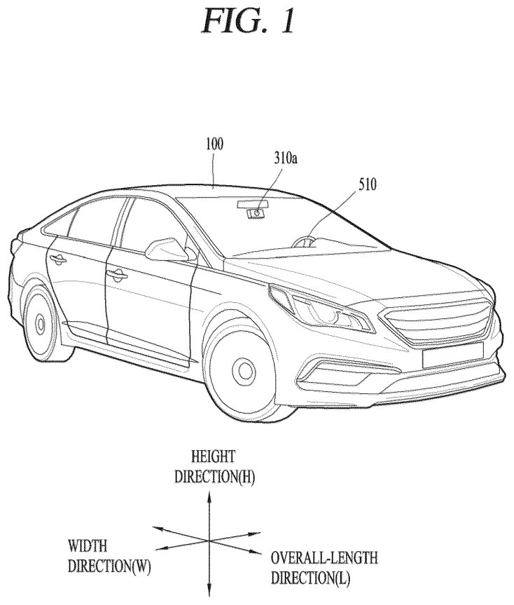

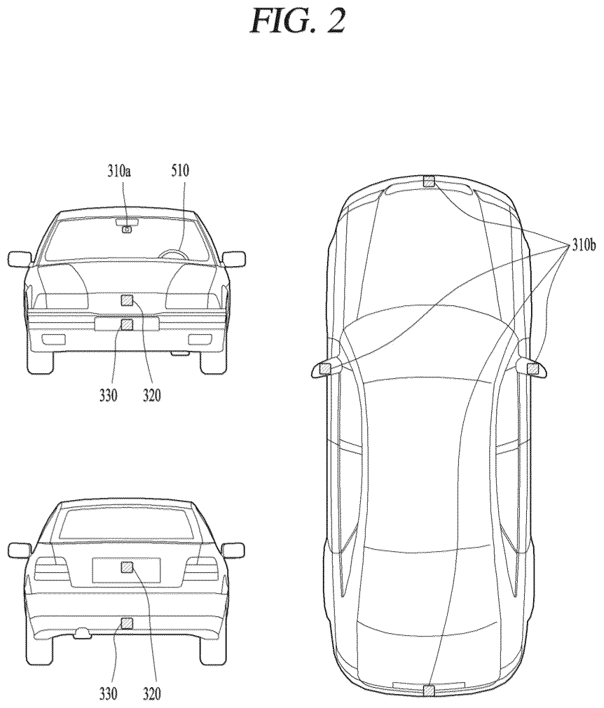

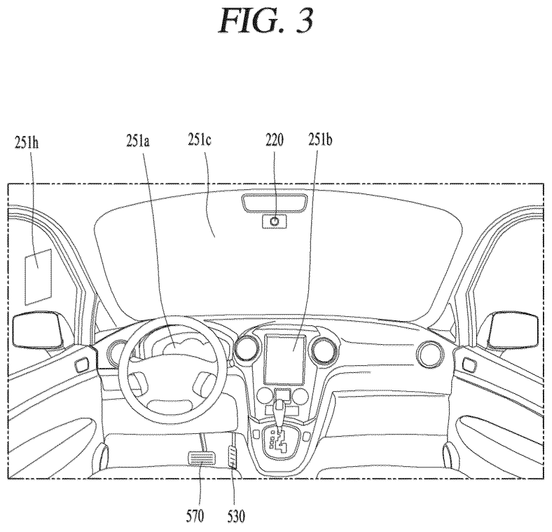

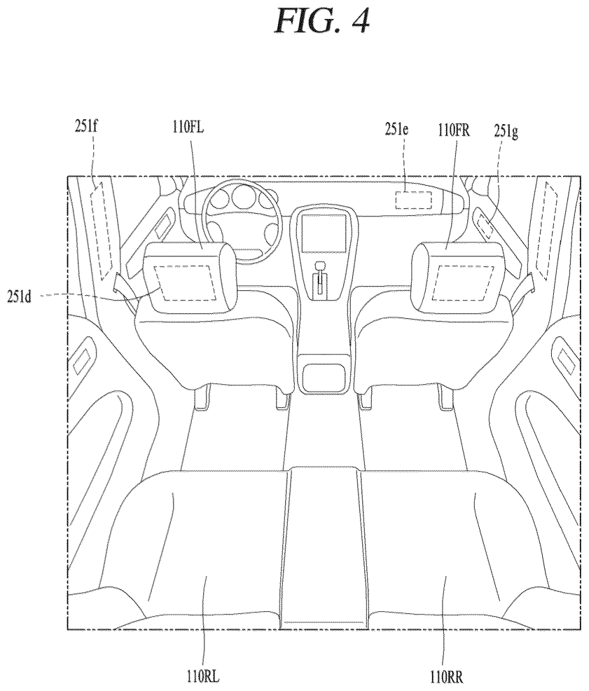

FIGS. 1 and 2 are views each illustrating the exterior of the vehicle in accordance with the embodiment of the present disclosure. FIGS. 3 and 4 are views each illustrating the interior of the vehicle in accordance with the embodiment of the present disclosure.

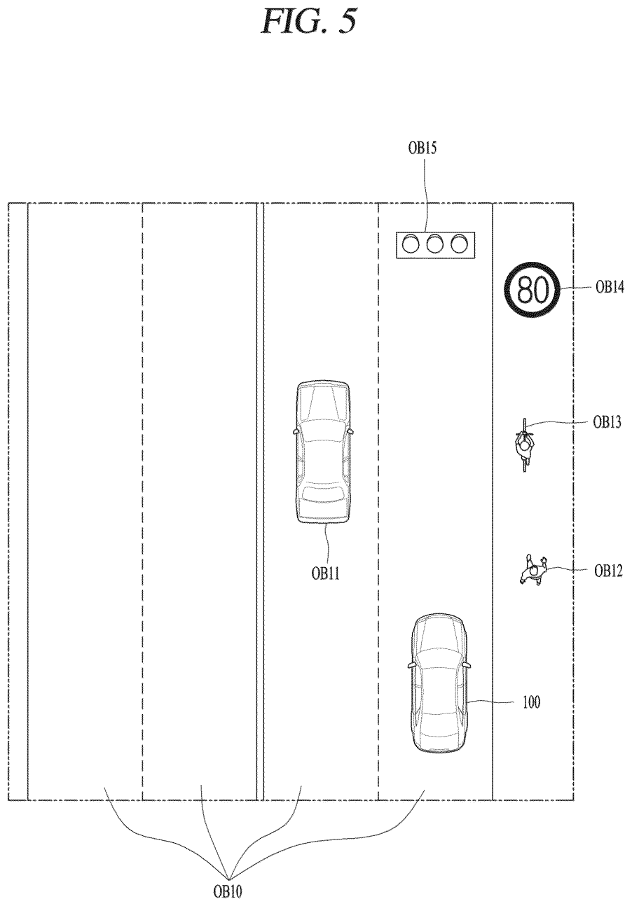

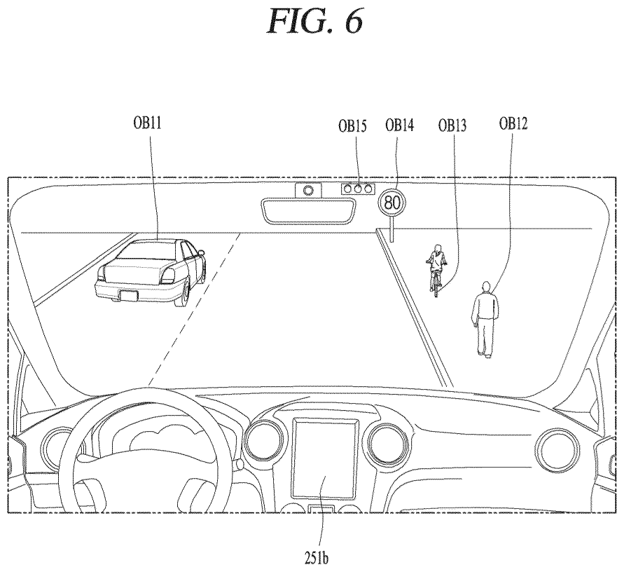

FIGS. 5 and 6 are views each illustrating various objects associated with the traveling of the vehicle in accordance with the embodiment of the present disclosure.

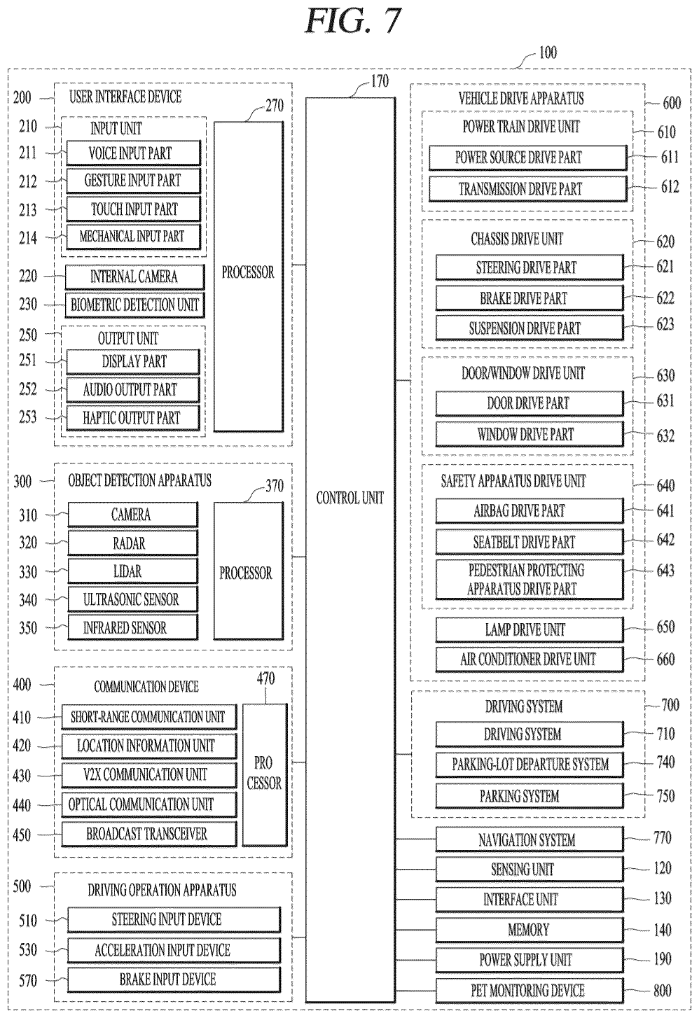

FIG. 7 is a block diagram that is referenced to describe the vehicle in accordance with the embodiment of the present disclosure. FIG. 7 is a block diagram that is referenced to describe the vehicle according to the embodiment of the present disclosure.

With reference to FIGS. 1 to 7, a vehicle 100 may include wheels that rotate by a power source and a steering input apparatus 510 for adjusting the driving direction of the vehicle 100.

The vehicle 100 may be an autonomous traveling vehicle. The vehicle 100 may switch to an autonomous traveling mode or a manual mode on the basis of a user input. For example, the vehicle 100 may switch from the manual mode to the autonomous traveling mode or from the autonomous traveling mode to the manual mode on the basis of a user input through a user interface device 200 (hereinafter referred to as a ‘user terminal’)

The vehicle 100 may switch to the autonomous traveling mode or the manual mode on the basis of the traveling situation information. A traveling situation information may be generated on the basis of object information provided by the object detection apparatus 300. For example, the vehicle 100 may switch from the manual mode to the autonomous traveling mode or from the autonomous traveling mode to the manual mode on the basis of the traveling situation information generated by the object detection apparatus 300. For example, the vehicle 100 may switch from the manual mode to the autonomous traveling mode or from the autonomous traveling mode to the manual mode on the basis of the traveling situation information through a communication device 400.

The vehicle 100 may switch from the manual mode into the autonomous traveling mode or from the autonomous traveling mode to the manual mode on the basis of information, data, signals, all of which are provided by an external device.

In a case where the vehicle 100 may be driven in the autonomous traveling mode, the vehicle 100 may be driven through the use of a driving system 700. For example, the vehicle 100 may be driven on the basis of information, data, and signals, all of which are generated by a traveling system 710, a parking-lot departure system 740, and a parking system 750.

When the vehicle 100 is driven in the manual mode, the vehicle 100 may receive the user input for driving through a driving operation apparatus 500. The vehicle 100 may be driven on the basis of the user input received through the driving operation apparatus 500.

The overall length refers to the length from the front end to the rear end of the vehicle 100, the width refers to the width of the vehicle 100, and the height refers to the length from the bottom of the wheel to the roof. In the following description, an overall-length direction L may refer to a direction which serves as a reference for measuring the overall length of the vehicle 100, a width direction W may refer to a direction that serves as a reference for measuring the width of the vehicle 100, and a height direction H may refer to a direction that serves as a reference for measuring the height of the vehicle 100.

As illustrated in FIG. 7, the vehicle 100 may include the user interface device (hereinafter referred to as the ‘user terminal’) 200, the object detection apparatus 300, the communication device 400, the driving operation apparatus 500, a vehicle drive apparatus 600, a driving system 700, a navigation system 770, a sensing unit 120, a vehicular interface unit 130, a memory 140, a control unit 170 and a power supply unit 190.

According to an embodiment, the vehicle 100 may further include one or more constituent elements in addition to constituent elements described in the present specification or may omit one or more of the described constituent elements.

The user interface device 200 is a device for communication between the vehicle 100 and the user. The user interface device 200 may receive the user input and may provide generated by the vehicle 100 to the user. The vehicle 100 may implement a user interface (UI) or user experience (UX) through the user interface device (hereinafter referred to as the ‘user terminal’) 200.

The user interface device 200 may include an input unit 210, an internal camera 220, a biometric detection unit 230, an output unit 250, and a processor 270. According to an embodiment, the user interface device 200 may further include one or more constituent elements in addition to constituent elements described in the present specification or may omit one or more of the described constituent elements.

The input unit 210 serves to receive information, as input, from the user. Data collected in the input unit 210 may be analyzed by the processor 270 and processed into a user's control command.

The input unit 210 may be arranged inside the vehicle 100. For example, the input unit 210 may be arranged on one region of the steering wheel, one region of the instrument panel, one region of the seat, one region of each pillar, one region of the door, one region of the center console, one region of the headlining, one region of the sun visor, one region of the windshield, one region of the window, or one region of a similar location.

The input unit 210 may include a voice input part 211, a gesture input part 212, a touch input part 213, and a mechanical input part 214.

The voice input part 211 may convert a user's voice input into an electric signal. The electric signal, resulting from the conversion, may be provided to the processor 270 or the control unit 170. The voice input part 211 may include at least one microphone.

The gesture input part 212 may convert a user's gesture input into an electric signal. The electric signal, resulting from the conversion, may be provided to the processor 270 or the control unit 170.

The gesture input part 212 may include at least one of the following: an infrared sensor or an image sensor, each of which is for detecting the user's gesture input. According to an embodiment, the gesture input part 212 may detect a user's three-dimensional (3D) gesture input. To this end, the gesture input part 212 may include a light-emitting diode, which emits a plurality of infrared rays. or a plurality of image sensors.

The gesture input part 212 may detect the user's 3D gesture input through a time of flight (TOF) method, a structured light method, or a disparity method.

The touch input part 213 may convert the user's touch input into an electric signal. The electric signal, resulting from the conversion, may be provided to the processor 270 or the control unit 170.

The touch input part 213 may include a touch sensor for detecting the user's touch input. According to an embodiment, the touch input part 213 may be integrally formed with a display part 251, thereby implementing a touch screen. This touch screen may provide both an input interface and an output interface between the vehicle 100 and the user.

The mechanical input part 214 may include at least one of the following: a button, a dome switch, a jog wheel, or a jog switch. An electric signal generated by the mechanical input part 214 may be provided to the processor 270 or the control unit 170. The mechanical input part 214 may be arranged on a steering wheel, a center fascia, a center console, a cockpit module, a door, and the like.

The internal camera 220 may acquire an image of the interior of the vehicle 100. The processor 270 may detect a user's state on the basis of the image of the interior of the vehicle 100. The processor 270 may acquire the user's gaze information from the image of the interior of the vehicle 100. The processor 270 may detect the user's gesture from the image of the interior of the vehicle 100.

The biometric detection unit 230 may acquire the user's biometric information. The biometric detection unit 230 may include a sensor for acquiring the user's biometric information and may acquire the user's fingerprint information, heart rate information, and the like using the sensor. The biometric information may be used for user authentication.

The output unit 250 may generate an output associated with sight, hearing, or touch. The output unit 250 may include at least one of the following: the display part 251, an audio output part 252, or a haptic output part 253.

The display part 251 may output graphic objects corresponding to various types of information. The display part 251 may include at least one of the following: a liquid crystal display (LCD), a thin film transistor-LCD (TFT LCD), an organic light-emitting diode (OLED), a flexible display, a three-dimensional (3D) display, or an e-ink display.

The display part 251 may be inter-layered with, or integrally formed with, the touch input part 213, thereby implementing a touch screen.

The display part 251 may be implemented as a head-up display (HUD). In a case where the display part 251 may be implemented as the HUD, the display part 251 may be equipped with a projection module and thus may output information through an image that is projected onto a window shield or a window.

An example of the display part 251 may be a transparent display. The transparent display may be attached to the windshield or the window. The transparent display may have a predetermined degree of transparency and may output a predetermined screen thereon. The transparent display may include at least one of the following: a thin film electroluminescent (TFEL), a transparent organic light-emitting diode (OLED), a transparent a liquid crystal display (LCD), a transmissive transparent display, or a transparent light-emitting diode (LED) display. The transparent display may have adjustable transparency.

The user interface device 200 may include a plurality of display parts, for example, display parts 251a to 251g.

The display part 251 may be arranged on one region of the steering wheel, one region 521a, 251b, or 251e of the instrument panel, one region 251d of the seat, one region 251f of each pillar, one region 251g of the door, one region of the center console, one region of the headlining, or one region of the sun visor, or may be implemented on one region 251c of the windshield, or one region of the window.

The audio output part 252 converts an electric signal provided from the processor 270 or the control unit 170 into an audio signal and outputs the audio signal. To this end, the audio output part 252 may include at least one speaker.

The haptic output part 253 generates a tactile output. For example, the haptic output part 253 may operate to vibrate the steering wheel, the safety belt, and the seats 110FL, 110FR, 110RL, and 110RR, thereby enabling the user to recognize the vibration output.

The processor (hereinafter referred to as the ‘control unit’) 270 may control the overall operation of each unit of the user interface device 200. According to an embodiment, the user interface device 200 may include a plurality of processors 270 or may not include any processor 270.

In a case where the processor 270 is not included in the user interface device 200, the user interface device 200 may operate under the control of a processor of another apparatus within the vehicle 100 or under the control of the control unit 170.

The user interface device 200 may be referred to as a vehicular display apparatus. The user interface device 200 may operate under the control of the control unit 170.

The object detection apparatus 300 is an apparatus for detecting an object located outside the vehicle 100. Examples of the object may include a variety of things associated with the driving of the vehicle 100. With reference to FIGS. 5 and 6, examples of an object O may include a traffic lane OB10, a different vehicle OB11, a pedestrian OB12, a two-wheeled vehicle OB13, traffic signals OB14 and OB15, ambient light, a road, a structure, a speed bump, a terrain feature, an animal, and the like.

The lane OB10 may be a traveling lane, a lane adjacent to the traveling lane, or a lane along which another vehicle in the opposite direction travels. The lane OB10 may conceptually include the left and right boundary lines forming a lane.

The different vehicle OB11 may be a vehicle which travels in the vicinity of the vehicle 100. The different vehicle OB11 may be a vehicle located within a predetermined distance from the vehicle 100. For example, the different vehicle OB11 may be a vehicle which travels ahead of or behind the vehicle 100.

The pedestrian OB12 may be a person located in the vicinity of the vehicle 100. The pedestrian OB12 may be a person located within a predetermined distance from the vehicle 100. For example, the pedestrian OB12 may be a person located on a sidewalk or roadway.

The two-wheeled vehicle OB12 may be a person-carrying vehicle that is located in the vicinity of the vehicle 100 and moves on two wheels. The two-wheeled vehicle OB12 may be a person-carrying vehicle that is located within a predetermined distance from the vehicle 100 and has two wheels. For example, the two-wheeled vehicle OB13 may be a motorcycle or a bicycle that is located on a sidewalk or roadway.

Examples of the traffic signal may include a traffic light OB15, a traffic sign OB14, and a pattern or text drawn on a road surface.

The ambient light may be light generated from a lamp provided on another vehicle. The ambient light may be light generated from a streetlamp. The ambient light may be solar light.

Examples of the road may include a road surface, a curve, an upward slope, a downward slope, and the like.

The structure may be an object that is located in the vicinity of a road and fixed on the ground. Examples of the structure may include a streetlamp, a roadside tree, a building, an electric pole, a traffic light, a bridge, and the like.

Examples of the terrain feature may include a mountain, a hill, and the like.

Objects may be classified into moving objects and stationary objects. Examples of the moving object may conceptually include another vehicle and a pedestrian. Examples of the stationary object may include a traffic signal, a road, and a structure.

The object detection apparatus 300 may include a camera 310, a radar 320, a LIDAR 330, an ultrasonic sensor 340, an infrared sensor 350, and a processor 370.

According to an embodiment, the object detection apparatus 300 may further include one or more constituent elements in addition to constituent elements described in the present specification or may omit one or more of the described constituent elements.

The camera 310 may be located in an appropriate portion of the exterior of the vehicle to acquire an image of the surroundings of the vehicle 100. The camera 310 may be a mono camera, a stereo camera 310a, an Around View Monitoring (AVM) camera 310b, or a 360-degree camera.

For example, the camera 310 may be arranged adjacent to a front windshield within the vehicle 100 to acquire an image of the surroundings in front of the vehicle 100. Alternatively, the camera 310 may be arranged in the vicinity of the front bumper or the radiator grill.

For example, the camera 310 may be arranged adjacent to a rear glass pane within the vehicle 100 to acquire an image of the surroundings behind the vehicle 100. Alternatively, the camera 310 may be arranged adjacent to the rear bumper, the trunk, or the tail gate.

For example, the camera 310 may be arranged adjacent to at least one of the side windows within the vehicle 100 to acquire an image of the surroundings alongside the vehicle 100. Alternatively, the camera 310 may be arranged in the vicinity of the side mirror, the fender, or the door.

The camera 310 may provide an acquired image to the processor 370.

The radar 320 may include an electromagnetic wave transmission unit and an electromagnetic wave reception unit. The radar 320 may be implemented in compliance with a pulse radar scheme or a continuous wave radar scheme according to the principle of emitting a radio wave. The radar 320 may be implemented in compliance with a Frequency Modulated Continuous Wave (FMCW) scheme or a Frequency Shift Keying (FSK) scheme, each of which is among continuous wave radar schemes, according to a signal waveform.

The radar 320 may detect an object using a time of flight (TOF) technique or a phase-shift technique, with an electromagnetic wave as a medium, and may detect a location of the detected object, a distance to the detected object, and a relative speed with respect to the detected object.

The radar 320 may be arranged in an appropriate position on the exterior of the vehicle 100 to detect an object that is located in front of, behind, or alongside the vehicle 100.

The LiDAR 330 may include a laser transmission unit and a laser reception unit. The LiDAR 330 may be implemented using a time of flight (TOF) technique or a phase-shift technique.

The LiDAR 330 may be implemented as a drive type or non-drive type LiDAR.

In a case where the LiDAR 330 may be implemented as a drive type LiDAR, the LiDAR 330 may be rotated by a motor and may detect an object in the vicinity of the vehicle 100.

In a case where the LiDAR 330 may be implemented as a non-drive type LiDAR, the LiDAR 330 may detect, through light steering, an object located within a predetermined range of the vehicle 100. The vehicle 100 may include a plurality of non-drive type LiDARs 330.

The LiDAR 330 may detect an object using a time of flight (TOF) technique or a phase-shift technique, with laser light as a medium, and may detect a location of the detected object, a distance to the detected object and a relative speed with respect to the detected object.

The radar 330 may be arranged in an appropriate position on the exterior of the vehicle 100 to detect an object that is located in front of, behind, or alongside the vehicle 100.

The ultrasonic sensor 340 may include an ultrasonic wave transmission unit and an ultrasonic wave reception unit. The ultrasonic sensor 340 may detect an object using an ultrasonic wave and may detect a position of the detected object, a distance to the detected object and a relative speed with respect to the detected object.

The ultrasonic sensor 340 may be arranged in an appropriate position on the exterior of the vehicle 100 to detect an object located in front of, behind, or alongside the vehicle 100.

The infrared sensor 350 may include an infrared ray transmission unit and an infrared ray reception unit. The infrared sensor 340 may detect an object on the basis of infrared light, and may detect a location of the detected object, a distance from the detected object and a relative speed with the detected object.

The infrared sensor 350 may be arranged in an appropriate position on the exterior of the vehicle 100 to detect an object located in front of, behind, or alongside the vehicle 100.

The processor 370 may control the overall operation of each unit of the object detection apparatus 300.

The processor 370 may detect an object on the basis of an acquired image and may track the object. The processor 370 may perform operations, such as calculation of a distance to an object and calculation of a relative speed with respect to the object, through an image processing algorithm.

The processor 370 may detect an object on the basis of a reflected electromagnetic wave, resulting from an emitted electromagnetic wave being reflected off the object, and may track the object. The processor 370 may perform operations, such as calculation of a distance to the object and calculation of a relative speed with respect to the object, on the basis of the electromagnetic wave.

The processor 370 may detect an object on the basis of a reflected laser beam, resulting from an emitted laser being reflected off the object, and may track the object. The processor 370 may perform operations, such as calculation of a distance to the object and calculation of a relative speed with respect to the object, on the basis of the laser beam.

The processor 370 may detect an object on the basis of a reflected ultrasonic wave, resulting from an emitted ultrasonic wave being reflected off the object, and may track the object. The processor 370 may perform operations, such as calculation of a distance to the object and calculation of a relative speed with respect to the object, on the basis of the ultrasonic wave.

The processor 370 may detect an object on the basis of reflected infrared light, resulting from emitted infrared light being reflected off the object, and may track the object. The processor 370 may perform operations, such as calculation of a distance to the object and calculation of a relative speed with respect to the object, on the basis of the infrared light.

According to an embodiment, the object detection apparatus 300 may include a plurality of processors 370 or may not include any processor 370. For example, each of the following: the camera 310, the radar 320, the LiDAR 330, the ultrasonic sensor 340, and the infrared sensor 350 may include its own processor individually.

In a case where the processor 370 is not included in the object detection apparatus 300, the object detection apparatus 300 may operate under the control of a processor of an apparatus within the vehicle 100 or under the control of the control unit 170.

The object detection device 400 may operate under the control of the control unit 170.

The communication device 400 is a device for performing communication with an external device. The external device here may be another vehicle, a mobile terminal, or a server.

To perform communication, the communication device 400 may include a transmission antenna, a reception antenna, and at least one of the following: a radio frequency (RF) circuit or an RF device, each of which is capable of implementing various communication protocols.

The communication device 400 may include a short-range communication unit 410, a location information unit 420, a V2X c [symbol] 430, an optical communication unit 440, a broadcast transceiver 450, and a processor 470.

According to an embodiment, the communication device 400 may further include one or more constituent elements in addition to constituent elements in the present specification or may omit one or more of the described constituent elements.

The short-range communication unit 410 is a unit for short-range communication. The short-range communication unit 410 may support short-range communication using at least one of the following technologies: Bluetooth™, Radio Frequency IDentification (RFID), Infrared Data Association (Ir DA), Ultra-Wide Band (UWB), Zig Bee, Near Field Communication (NFC), Wireless-Fidelity (WI-Fi), Wi-Fi Direct, or Wireless Universal Serial Bus (USB).

The short-range communication unit 410 may form short-range wireless area networks and may perform short-range communication between the vehicle 100 and at least one external device.

The location information unit 420 is a unit for acquiring location information of the vehicle 100. For example, the location information unit 420 may include a Global Positioning System (GPS) module or a Differential Global Positioning System (DGPS) module.

The V2X communication unit 430 is a unit for performing wireless communications with a server (Vehicle to Infrastructure, V2I), another vehicle (Vehicle to Vehicle, V2V), or a pedestrian (Vehicle to Pedestrian, V2P). The V2X communication unit 430 may include an RF circuit capable of implementing protocols for communication with an infrastructure (V2I), communication between vehicles (V2V), and communication with a pedestrian (V2P).

The optical communication unit 440 is a unit for performing communication with an external device, with light as a medium. The optical communication unit 440 may include an optical transmission part for converting an electric signal into an optical signal and transmitting the optical signal to the outside, and an optical reception part for converting the received optical signal back into an electric signal.

According to an embodiment, the optical transmission part may be formed integrally with a lamp provided on the vehicle 100.

The broadcast transceiver 450 is a unit for receiving a broadcast signal from an external broadcast management server or transmitting a broadcast signal to the broadcast managing server over a broadcast channel. The broadcast channel may include a satellite channel, a terrestrial channel, or both. The broadcast signal may include a TV broadcast signal, a radio broadcast signal, and a data broadcast signal.

The processor 470 may control the overall operation of each unit of the communication device 400.

According to an embodiment, the communication device 400 may include a plurality of processors 470 or may not include any processor 470.

In a case where the processor 470 is not included in the communication device 400, the communication device 400 may operate under the control of a processor of another device within the vehicle 100 or under the control of the control unit 170.

The communication device 400, along with the user interface device 200, may implement a vehicular display device. In this case, the vehicular display device may be referred to as a telematics device or an Audio Video Navigation (AVN) device.

The communication device 400 may operate under the control of the control unit 170.

The driving operation apparatus 500 is an apparatus for receiving a user input for driving.

In the manual mode, the vehicle 100 may be driven on the basis of a signal provided by the driving operation apparatus 500.

The driving operation apparatus 500 may include the steering input device 510, an acceleration input device 530 and a brake input device 570.

The steering input apparatus 510 may receive an input regarding the driving direction of the vehicle 100 from the user. The steering input apparatus 510 is preferably configured in the form of a wheel, allowing a steering input by the wheel's rotation. According to an embodiment, the steering input apparatus may also be configured in the shape of a touch screen, a touch pad, or a button.

The acceleration input apparatus 530 may receive an input for accelerating the vehicle 100 from the user. The brake input apparatus 570 may receive an input for decelerating the vehicle 100 from the user. The acceleration input apparatus 530 and the brake input apparatus 570 are preferably configured in the shape of a pedal. According to an embodiment, the acceleration input apparatus or the brake input apparatus may also be configured in the shape of a touch screen, a touch pad or a button.

The driving operation apparatus 500 may operate under the control of the control unit 170.

The vehicle drive apparatus 600 is an apparatus that electrically controls driving of the various apparatuses within the vehicle 100.

The vehicle drive apparatus 600 may include a power train drive unit 610, a chassis drive unit 620, a door/window drive unit 630, a safety apparatus drive unit 640, a lamp drive unit 650, and an air-conditioner drive unit 660.

According to an embodiment, the vehicle drive apparatus 600 may further include one or more constituent elements in addition to constituent elements in the present specification or may omit one or more of the described constituent elements.

The vehicle drive apparatus 600 may include a processor. Each unit of the vehicle drive apparatus 600 may individually include its own processor.

The power train drive unit 610 may control the operation of a power train apparatus.

The power train drive unit 610 may include a power source drive part 611 and a transmission drive part 612.

The power source drive part 611 may execute control on the power source of the vehicle 100.

For example, in a case where the power source of the vehicle 100 is a fossil fuel-based engine, the power source drive part 611 may execute electronic control on the engine. Accordingly, the output torque and other parameters of the engine may be controlled. The power source drive part 611 may adjust the engine output torque under the control of the control unit 170.

For example, in a case where the power source of the vehicle 100 is an electric energy-based motor, the power source drive part 611 may execute control on the motor. The power source drive part 611 may adjust a rotational speed, torque, and other parameters of the motor under the control of the control unit 170.

The transmission drive part 612 may execute control on a transmission. The transmission drive gearbox part 612 may adjust the state of the transmission. The transmission drive part 612 may change the state of the transmission to Drive (D), Reverse (R), Neutral (N), or Park (P).

In a case where the power source of the vehicle 100 is an engine, the transmission drive part 612 may adjust the engaged state of a gear in Drive (D).

The chassis drive unit 620 may control the operation of a chassis apparatus. The chassis drive unit 620 may include a steering drive part 621, a brake drive part 622, and a suspension drive part 623.

The steering drive part 621 may execute electronic control on a steering apparatus within the vehicle 100. The steering drive part 621 may change the driving direction of the vehicle 100.

The brake drive part 622 may execute electronic control on a brake apparatus within the vehicle 100. For example, the brake drive part 622 may reduce the speed of the vehicle 100 by controlling the operation of the brakes provided on the wheels.

The brake drive part 622 may individually control each of the brakes. The brake drive part 622 may control braking forces applied to the wheels so that they differ from one another.

The suspension drive part 623 may execute electronic control on a suspension apparatus within the vehicle 100. For example, in a case where a road surface is uneven, the suspension drive part 623 may reduce vibration of the vehicle 100 by controlling the suspension apparatus. The suspension drive part 623 may individually control each of the plurality of suspensions.

The door/window drive unit 630 may execute electronic control on a door apparatus or a window apparatus within the vehicle 100.

The door/window drive unit 630 may include a door drive part 631 and a window drive part 632.

The door drive part 631 may execute control on the door apparatus. The door drive part 631 may control the opening or closing of the plurality of doors included in the vehicle 100. The door drive part 631 may control the opening or closing of the trunk or the tailgate. The door drive part 631 may control the opening or closing of the sunroof.

The window drive part 632 may execute electronic control on the window apparatus. The window drive part 632 may control the opening or closing of the plurality of windows included in the vehicle 100.

The safety apparatus drive unit 640 may execute electronic control on the various safety apparatuses within the vehicle 100.

The safety apparatus drive unit 640 may include an airbag drive part 641, a seatbelt drive part 642, and a pedestrian protection apparatus drive part 643.

The airbag drive part 641 may execute electronic control on the airbag apparatus within the vehicle 100. For example, when a risk is detected, the airbag drive part 641 may control the airbag to deploy.

The seatbelt drive part 642 may execute electronic control on the seatbelt apparatus within the vehicle 100. For example, when a risk is detected, the seatbelt drive part 642 may secure the occupants in seats 110FL, 110FR, 110RL, and 110RR by tightening seatbelts.

The pedestrian protection apparatus drive part 643 may execute electronic control on the hood lift and the pedestrian airbag. For example, when a collision with a pedestrian is detected, the pedestrian protection apparatus drive part 643 may control the hood lift and the pedestrian airbag to deploy.

The lamp drive part 650 may execute electronic control on the various lamp apparatuses within the vehicle 100.

The air-conditioner drive unit 660 may execute electronic control on the air conditioner within the vehicle 100. For example, when the temperature inside the vehicle 100 is high, the air-conditioner drive unit 660 may control the air conditioner to operate in such a manner as to supply cool air into the vehicle 100.

The vehicle drive apparatus 600 may include a processor. Each unit of the vehicle drive apparatus 600 may individually include its own processor.

The vehicle drive apparatus 600 may operate under the control of the control unit 170.

The driving system 700 is a system that controls various driving functions of the vehicle 100. The driving system 700 may operate in the autonomous traveling mode.

The driving system 700 may include the traveling system 710, the parking-lot departure system 740, and the parking system 750.

According to an embodiment, the driving system 700 may further include one or more constituent elements in addition to constituent elements described in the present disclosure or may emit one or more of the described constituent elements.

The driving system 700 may include a processor. Each unit of the driving system 700 may individually include its own processor.

According to an embodiment, in a case where the driving system 700 may be implemented in software, the driving system 700 may also conceptually operate at a lower level than the control unit 170.

According to an embodiment, the driving system 700 may conceptually include at least one of the following: the user interface device 200, the object detection apparatus 300, the communication device 400, the vehicle drive apparatus 600, or the control unit 170.

The traveling system 710 may enable the vehicle 100 to travel.

The traveling system 710 may receive navigation information from a navigation system 770, may provide a control signal to the vehicle drive apparatus 600, and may enable the vehicle 100 to travel. The traveling system 710 may receive object information from the object detection apparatus 300, may provide a control signal to the vehicle drive apparatus 600 and may enable the vehicle 100 to travel. The traveling system 710 may receive a signal from an external device through the communication device 400, may provide a control signal to the vehicle drive apparatus 600, and may enable the vehicle 100 to travel.

The parking-lot departure system 740 may perform a departure maneuver for the vehicle 100.

The parking-lot departure system 740 may receive navigation information from the navigation system 770, may provide a control signal to the vehicle drive apparatus 600, and may perform a departure maneuver for the vehicle 100. The parking-lot departure system 740 may receive object information from the object detection apparatus 300, may provide a control signal to the vehicle drive apparatus 600, and may perform a departure maneuver for the vehicle 100. The parking-lot departure system 740 may receive a signal from an external device through the communication device 400, may provide a control signal to the vehicle drive apparatus 600, and may perform a departure maneuver for the vehicle 100.

The parking system 750 may perform a parking maneuver for the vehicle 100.

The parking system 750 may receive navigation information from the navigation system 770, may provide a control signal to the vehicle drive apparatus 600, and may perform a parking maneuver for the vehicle 100. The parking system 750 may receive object information from the object detection apparatus 300, may provide a control signal to the vehicle drive apparatus 600 and may perform a parking maneuver for the vehicle 100. The parking system 750 may receive a signal from an external device through the communication device 400, may provide a control signal to the vehicle drive apparatus 600, and may perform a parking maneuver for the vehicle 100.

The navigation system 770 may provide navigation information. The navigation information may include at least one of the following: map information, set-destination information, path information based on the set destination, information about various objects on a path, lane information, or current vehicular location information.

The navigation system 770 may include a memory and a processor. The navigation information may be stored in the memory. The processor may control the operation of the navigation system 770.

According to an embodiment, the navigation system 770 may update pre-stored information by receiving information from an external device through the communication device 400.

According to an embodiment, the navigation system 770 may also be classified as a sub-constituent element of the user interface device 200.

The sensing unit 120 may sense the state of the vehicle 100. The sensing unit 120 may include a posture sensor (for example, a yaw sensor, a roll sensor, a pitch sensor, or the like), a collision sensor, a wheel sensor, a speed sensor, a tilt sensor, a weight-detection sensor, a heading sensor, a gyro sensor, a position module, a vehicle forward/backward movement sensor, a battery sensor, a fuel sensor, a tire sensor, a steering sensor sensing the turning of a steering wheel, an in-vehicle temperature sensor, an in-vehicle humidity sensor, an ultrasonic sensor, an illumination sensor, an accelerator position sensor, a brake pedal position sensor, and other sensors.

The sensing unit 120 may acquire vehicular posture information, vehicular collision information, vehicular direction information, vehicular location information (GPS information), vehicular angle information, vehicular speed information, vehicular acceleration information, vehicular tilt information, vehicular forward/backward movement information, battery information, fuel information, tire information, vehicular lamp information, in-vehicle temperature information, and in-vehicle humidity information. Furthermore, the sensing unit 120 may acquire signals that result from sensing a steering wheel rotation angle, outside-vehicle illumination, pressure applied to an acceleration pedal, pressure applied to a brake pedal, and the like.

The sensing unit 120 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and other sensors.

The vehicular interface unit 130 may serve as a path to various types of external devices connected to the vehicle 100. For example, the vehicular interface unit 130 may include a port that enables a connection with a mobile terminal and may be connected to the mobile terminal through the port. In this case, the vehicular interface unit 130 may exchange data with the mobile terminal.

The vehicular interface unit 130 may serve as a path for supplying electric energy to the connected mobile terminal. In a case where the mobile terminal is electrically connected to the vehicular interface unit 130, the vehicular interface unit 130 may supply electric energy, supplied from the power supply unit 190, to the mobile terminal under the control of the control unit 170.

The memory 140 is electrically connected to the control unit 170. Basic data for the units, control data for controlling operations of the units, and data, which are input and output, may be stored in the memory 140. Examples of the memory 140 may include various hardware storage devices, such as a ROM, a RAM, an EPROM, a flash drive, and a hard drive. Programs for processing or control by the control unit 170, and various data for the overall operation of the vehicle 100 may be stored in the memory 140.

According to an embodiment, the memory 140 may be configured to be integrated with the control unit 170 or may be implemented as a sub-constituent element of the control unit 170.

The control unit 170 may control the overall operation of each unit within the vehicle 100. The control unit 170 may be referred to as an Electronic Control Unit (ECU).

The power supply unit 190 may supply power necessary for the operation of each constituent element under the control of the control unit 170. Specifically, the power supply unit 190 may receive power supplied from the battery inside the vehicle 100, or from other sources.

At least one processor and the control unit 170, which are included in the vehicle 100, may be implemented using at least one of the following: application-specific integrated circuits (ASICs), digital signal processors (DSPs), digital signal processing devices (DSPDs), programmable logic devices (PLDs), field programmable gate arrays (FPGAs), processors, controllers, micro controllers, microprocessors, or electric units performing other functions.

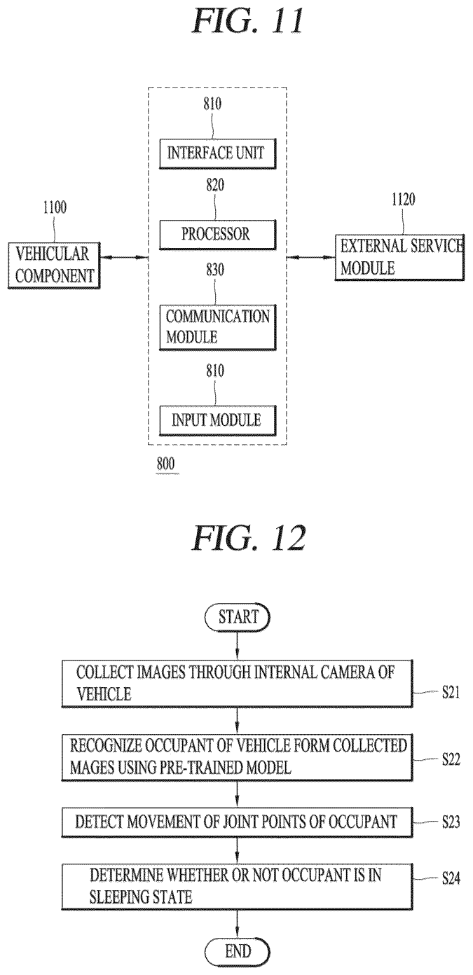

A vehicle monitoring device 800 may include an interface and a processor. The interface performs communication with at least one of the components provided in a vehicle. The processor monitors a state of an occupant inside the vehicle in a state where the vehicle is parked or stopped, monitors the movement of an object outside the vehicle, and generates an intervention signal. The vehicle monitoring device 800 may be implemented as one of the components of the vehicle and may be embedded into the vehicle or be present inside the vehicle in an attachable and detachable manner. An in-depth configuration of the vehicle monitoring device 800 is described in more detail below with reference to FIG. 11.

An HVAC system 780 may perform a cooling operation and a warming operation within the vehicle through a control module. In addition, the HVAC system 780 may be controlled to independently perform the cooling or warming operation to a desired level based on the position of each of the seats including the driver's seat, the front seats, and the rear seats. The HVAC system 780 may operate to adjust a set cooling or warming level on the basis of the temperature outside the vehicle and the temperature inside the vehicle.

An ANC system 790 is an apparatus/system that performs an active noise cancellation function of the vehicle. The ANC system 790, in its activated state, detects movement of the vehicle's engine or detects noise due to the operation of a heater and generates antiphase sound to counter the noise caused by the operation of the engine/heater. Consequently, through noise cancellation, the ANC system 790 operates to reduce the noise caused by the operation of the engine/heater within the vehicle. To this end, the ANC system 790 may include an external amplifier equipped with one or more ANC algorithms, a plurality of speakers, and a control module that controls these components.

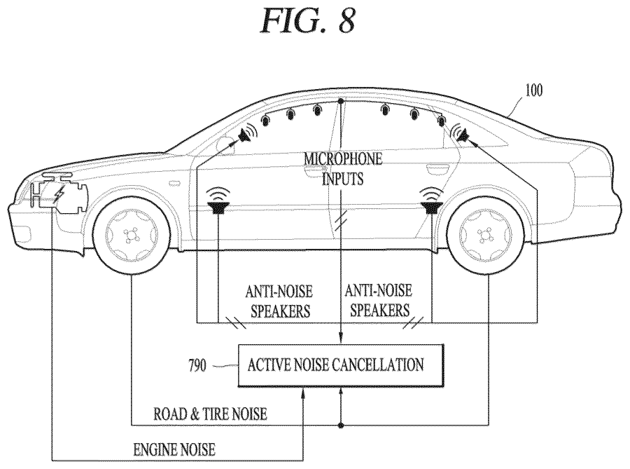

FIG. 8 is an illustrative view that is referenced to describe in more detail the active noise cancellation (ANC) function of the vehicle in accordance with the embodiment of the present disclosure.

Normally, ANC technology that applies to vehicles refers to a technology that detects an engine's movement and generates antiphase sound to counter noise from the engine, thereby reducing the vehicle's engine noise heard inside the vehicle through phase cancellation. Therefore, an ANC function of the vehicle is shortened for an active noise cancellation function of a vehicle.

According to the present disclosure, the ANC function that applies in the state where the vehicle is parked or stopped is described. The state where the vehicle is parked or stopped includes both when the vehicle operates and when the vehicle stops operating. Therefore, in the state where the vehicle is parked or stopped, the ANC function of the ANC system 790, which is disclosed in the present specification, reduces both the vehicle's engine noise and the vehicle's extraneous noise (including noise caused by the operation of the vehicle's heater and the cooling operation) when the vehicle operates and reduces the vehicle's extraneous noise when the vehicle stops operating.

The ANC function of the vehicle may be activated on the basis of a user input or when a predetermined condition ('starting condition') is satisfied. After being activated, the ANC function may be deactivated on the basis of a user input or when a predetermined condition ('cancellation condition') is satisfied.

As illustrated in FIG. 8, to perform the ANC function of the vehicle 100, the ANC system 790 of the vehicle may include a noise sensing module, a noise sensing module (for example, a microphone), an audio output module (for example, anti-noise speakers), and a noise control module (for example, a controller processor).

The noise sensing module senses noise from the vehicle 100's engine, noise from the road surface/tire, and noise (not shown) from the vicinity of the vehicle that is parked or stopped, using a plurality of microphones installed on a plurality of positions on the vehicle 100. To this end, as illustrated, multiple microphones may be arranged at predetermined distances apart on each of the front and rear seats of the vehicle.

The audio output module outputs electronic component sound to counter the noise from the engine and/or the noise from the vicinity of the vehicle under the control of the noise control module, using the speakers mounted on the vehicle.

The noise sensing module senses the electronic component sound, which is output through the audio output module, and transfers the sensed electronic sound to the noise control module. The noise control module determines whether or not a change occurs in characteristic, by comparing data, obtained from actually measuring the received electronic component sound, with preset reference data. When the result of the comparison indicates that a change occurs in at least one of the following: a frequency response characteristic or a phase characteristic, it is concluded that the cancellation condition is satisfied. Consequently, the ANC function may be deactivated. If not, the ANC function is maintained in an activated state. Then, an active noise cancellation operation of outputting an antiphase signal for canceling noise may be performed through software control that uses a digital signal processor (DSP).

In the present disclosure, a case where the ANC function is performed in various embodiments in the state where the vehicle is parked or stopped is described above. In this case, the activation of the ANC function may depend on whether or not an occupant is present in the vehicle, whether or not the occupant is an animal, and a state of the occupant. Embodiments in which the ANC function is activated or deactivated under various situational conditions in the state where the vehicle is parked or stopped will be described in more detail below.

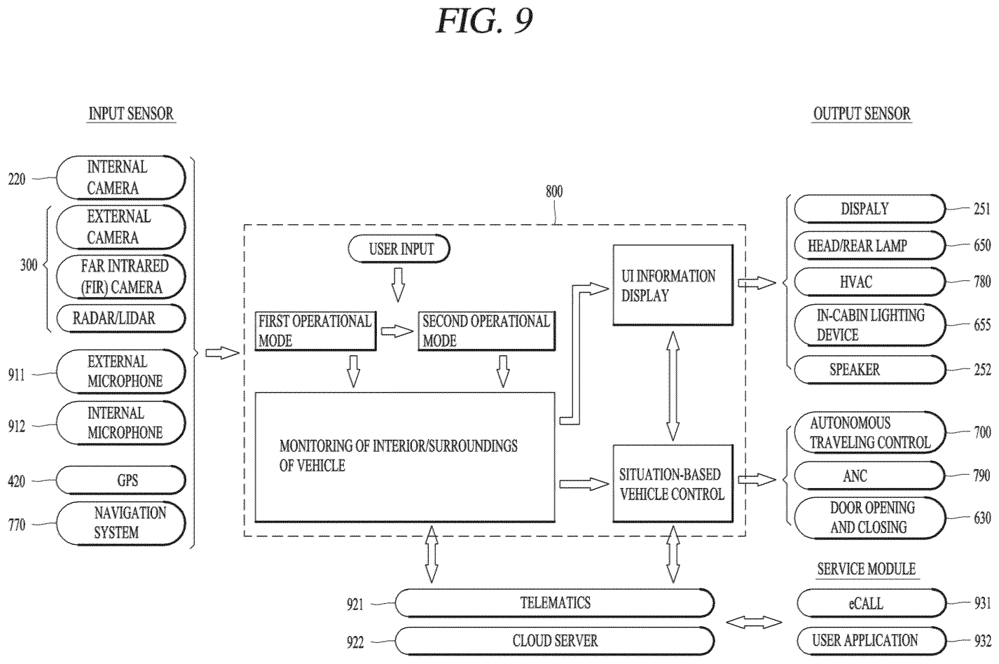

FIG. 9 is a diagram illustrating a conceptual system, which is referenced to describe the monitoring of the vehicle's interior and surroundings, UI information display, and situational-based vehicle control, all of which are in accordance with an embodiment of the present disclosure.

With reference to FIG. 9, in the illustrated system, the vehicle monitoring device 800 embedded/mounted in the vehicle may operate in conjunction with the vehicle/a plurality of input modules (input sensors) embedded in the vehicle, the vehicle/a plurality of output modules (output sensors) embedded in the vehicle, a telematics 921, a cloud server 922, and a service module that uses an e-Call 931, a user application 932, and the like. The telematics 921 performs communication using a wireless/wired communication scheme.

On the basis of the user input, the vehicle monitoring device 800 may drive a HVAC system for a pleasant in-vehicle environment and may execute a first operational mode for monitoring the interior of the vehicle or may selectively execute a second operational mode for monitoring the vicinity of the vehicle, that is, the surroundings of the vehicle.

Specifically, on the basis of a first input, the vehicle monitoring device 800 may provide a pleasant environment and may execute the first operational mode for monitoring the interior of the vehicle. In addition, on the basis of a second input, the vehicle monitoring device 800 may execute a second operational mode for monitoring the interior of the vehicle. In addition, on the basis of both the first input and second input, the vehicle monitoring device 800 may simultaneously execute the first and second operational modes for monitoring both the interior and surroundings of the vehicle.

Examples of operations in the first operational mode for monitoring the interior of the vehicle include an operation of monitoring the presence or absence of the occupant of the vehicle, the number and locations of the occupants, and the state (for example, sleepiness, sleep, anxiety, feeling hot, or feeling cold) of the occupant. This monitoring uses sensors (hereinafter referred to as ‘first sensors’), the internal camera 220 of the vehicle, a respiratory sensor, a biometric signal detection sensor, a microphone 912, and a vehicle occupancy sensor for each seat.

The first operational mode is an operational mode for providing a comfortable and pleasant in-cabin environment inside the vehicle. Examples of the first operational mode include an operation of maintaining in-vehicle temperature at a pleasant and comfortable level using the HVAC system 780, a temperature sensor, and the like. In addition, if necessary, music or a visual image, each of which creates a comfortable atmosphere, may be provided through an output unit, for example, a speaker or a display, inside the vehicle while the first operational mode is executed. The result of monitoring in the first operational mode may be displayed on an internal display of the vehicle or the like and may be transferred to a controller of the vehicle.

The second operational mode is an operational mode for monitoring the surroundings of the vehicle. In the second operational mode, an operation of monitoring the object in the vicinity of the vehicle is performed. This monitoring uses, for example, sensors (hereafter referred to as ‘second sensors’), such as an external vision sensor 300 (for example, an external camera, a Far Infrared (FIR) camera, and a radar/LiDAR) of the vehicle, an external microphone 911, and a GPS 420. The result of monitoring in the first operational mode may be checked through the internal display and/or external display of the vehicle and a registered user terminal and be transferred to the controller of the vehicle.

According to the present disclosure, in a state where the vehicle is parked or stopped, while only the first operational mode is executed on the basis of the first input, if a predetermined condition is satisfied, the second operational mode may be additionally executed without an additional input. At this point, the first operational mode and the second operational mode may be simultaneously executed. In addition, the second operational mode may be modified on the basis of the result of monitoring in the first operational mode.

Specifically, while the first operational mode is executed on the basis of the user input, when it is determined that the predetermined condition is satisfied, the vehicle monitoring device 800 may additionally execute the second operational mode. In this case, the second operational mode may be executed, considering the state of the vehicle occupant, which corresponds to the result of the monitoring in the first operational mode.

For example, while only the first operational mode is executed, in a case where it is determined that the occupant is in a sleep state, the second operational mode may be additionally executed to protect the occupant. At this point, the second operational mode may be executed in a state where the ANC function is activated.

In addition, while the first operational mode is executed, the vehicle monitoring device 800 may modify and perform the second operational mode on the basis of the result of monitoring the interior of the vehicle. Specifically, in the first operational mode, on the basis of the monitored state of the occupant, the vehicle monitoring device 800 may monitor the vicinity of the vehicle in a state where the ANC function is activated. Alternatively, the vehicle monitoring device 800 may execute an operational mode for monitoring the vicinity of the vehicle in a state where the ANC function is deactivated.

In addition, on the basis of the result of the monitoring in the second operational mode, the vehicle monitoring device 800 may modify the first operational mode or may discriminately provide a warning alarm corresponding to the result of the monitoring in the second operational mode.

For example, in a case where the result of the monitoring in the second operational mode indicates that sound in the vicinity of the vehicle needs to be transferred to the occupant, the ANC function may switch to a deactivated state, and the ANC function may operate in such a manner that the occupant checks the sound in the vicinity of the vehicle from inside the vehicle. In addition, for example, in a case where the occupant is in the sleeping state, the result of the monitoring in the second operational mode may be provided only in a visual form with the result being excluded from being provided in an audio form. In contrast, in a case where the sleeping state of the vehicle occupant continues in a dangerous situation, lighting in the interior of the cabin of the vehicle switches to a turned-on state, and/or warning alert sound may be output through an internal speaker of the vehicle.

In this manner, on the basis of the results of monitoring the interior and surroundings of the vehicle in the first and second operational modes in the vehicle monitoring device 800, various forms of situation-based warning alerts are output, and/or vehicle control is possible.

To this end, the vehicle monitoring device 800 may output a monitoring result, a warning alert, and an intervention operation using various output units embedded in the interior and exterior of the vehicle, for example, such as the display 251, a head/rear lamp 650, the HVAC system 780, an in-cabin lighting device 650, and a speaker 252.

These various output units may be adaptively and selectively used when the first operational mode and the second operational mode are executed. On the basis of the monitoring result, two or more of these various output units may be implemented as being used together or being at stepwise levels.

The vehicle monitoring device 800 may provide a user interface (UI) for checking the result of monitoring the surroundings of the vehicle in the second operational mode through at least one of the following: the internal display of the vehicle, the telematics, or the user terminal. For example, a user interface screen for checking detailed information about the object in the vicinity of the vehicle, which is recognized in the second operational mode, or for tracking the object may be provided on the display 251.

The vehicle monitoring device 800 may recognize the current location of the vehicle in the second operational mode using a GPS sensor 420 and the navigation 770 and may receive risk-level history information for the current location of the vehicle through communication with the telematics 921 and the cloud server 922.

The vehicle monitoring device 800 may set an intervention policy for each object in the vicinity of the vehicle on the basis of the received risk-level history information for the current location of the vehicle. For example, in a case where the risk level of the current location of the vehicle is lower than a reference level, the intervention policy may be set in such a manner that a more flexible warning alert is output. Conversely, in a case where the risk level of the current location of the vehicle is equal to or higher than the reference level, the intervention policy may be set in such a manner that a more subtle warning alert is output.

In addition, on the basis of the results of monitoring in the first and second operational modes, the vehicle monitoring device 800 may perform autonomous-traveling control 700 and may control the ANC system 790, door opening and closing 630, and the like, in addition to the warning alert.

For example, in a case where the result of monitoring in the second operational mode indicates that the sound in the vicinity of the vehicle needs to be checked from inside the vehicle, the vehicle monitoring device 800 may generate a control signal for switching the ANC function to a deactivated state and may transfer the generated control signal to the ANC system 790.

In addition, in a case where the result of monitoring in the second operational mode indicates that an emergency situation such as a vehicle break-in attempt occurs, the vehicle monitoring device 800 may transfer a signal for the autonomous-traveling control 700 to the controller of the vehicle. In this case, in order to move the vehicle, the vehicle monitoring device 800 may perform the autonomous-traveling control 700 through communication with the cloud server 922 and the negation 770 of the vehicle.

In addition, for example, in a case where the result of monitoring in the second operational mode indicates that the recognized object approaches the vehicle within a threshold distance, the vehicle monitoring device 800 may control the door opening and closing 630 for door lock.

Additionally, in an emergency situation, the vehicle monitoring device 800 may automatically connect to the eCall 931 through the telematics 921 and/or the cloud server 922. In this case, the vehicle monitoring device 800 may provide the results of monitoring in the first and second operational modes to the eCall 931. Moreover, through the user application 932 on the user terminal, the vehicle monitoring device 800 may also check the results of monitoring in the first and second operational modes and may transfer a request for permission to perform the autonomous-traveling control 700 to the user terminal.

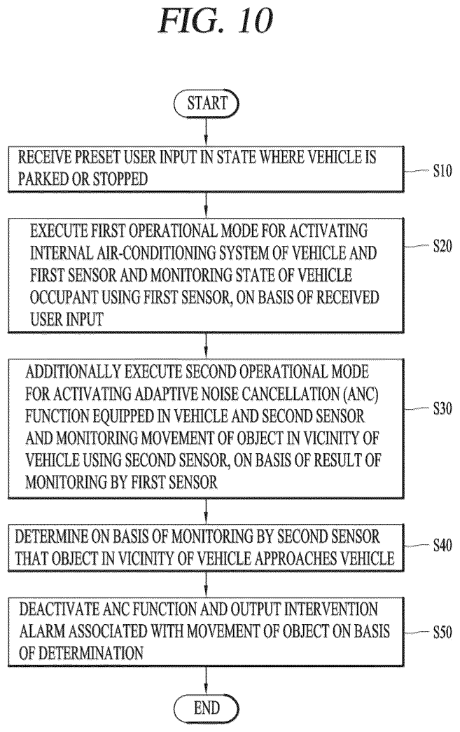

FIG. 10 is a representative flowchart that is referenced to describe a method of operating the vehicle in accordance with the embodiment of the present disclosure.

Unless otherwise described, steps of the method of operating the vehicle, which are illustrated in FIG. 10, may be performed by the main controller or processor of the vehicle. In addition, each step may also be performed by the processor of the vehicle monitoring device according to an embodiment of the present disclosure.

With reference to FIG. 10, first, a step of receiving a preset user input in the state where the vehicle is parked or stopped input starts (S10).

At this point, the state where the vehicle is parked or stopped refers to a state where the vehicle remains stationary for a predetermined time or longer after stopping or a step where the vehicle is fully parked. In addition, the state where the vehicle is parked or stopped includes not only a state where an occupant, such as a driver, is present inside the vehicle, but also a state where the doors of the vehicle are opened in order for all occupants to get out of the vehicle.

In the present specification, in the state where the vehicle is parked or stopped, after the vehicle stops operating or automatically stops operating after a predetermined time has elapsed, the vehicle may be set to execute a preset operational mode or to operate the vehicular electronic component or a similar component to support this execution. To this end, in the state where the vehicle is parked or stopped, it may be detected whether or not a preset user input is received.

The user input may be applied through an input unit (a button, a touch screen, or a microphone for recognizing voice) provided in the vehicle/the vehicle monitoring device, and/or an input unit (a button, a touch screen, or a microphone for recognizing voice) provided in a device/terminal that communicates with the vehicle.

When the user input preset in this manner is received, an internal air-conditioning system (for example, the HVAC system) and a first sensor may be activated, and the first operational mode for monitoring the state of the vehicle occupant using the first sensor may be executed (S20).

In the first operational mode, both an operation of monitoring the interior of the vehicle and an operation of maintaining the interior of the cabin of the vehicle are performed to ensure a pleasant environment. Specifically, in the first operational mode, an operation of providing a pleasant in-vehicle environment is performed by operating the HVAC system that automatically adjusts cooling and warming inside the vehicle according to the set in-vehicle temperature, an air cleaning system, and similar systems. These operations may be performed regardless of whether or not an occupant is present in the vehicle. In addition, in the case of an electric motor or a hybrid electric vehicle, each using an electric motor, the first operational mode may also be executed in a state where the electric motor or the hybrid electric vehicle stops operating.

At this point, the set in-vehicle temperature may have a preset temperature value or a temperature value that is automatically adjusted according to the temperature outside the vehicle. In addition, the set in-vehicle temperature may be automatically adjusted according to the number of occupants and the state of the occupant (for example, a sleeping state, a hot-feeling state, or a cold-feeling state).

In addition, the operations of the HVAC system and the air cleaning system may be independently controlled for each occupant's location inside the vehicle or each seat (for example, each of the front seats or rear seats of the vehicle). For example, in a case where the temperature outside the vehicle satisfies a reference high-temperature condition, a difference in the in-vehicle temperature and perceived temperature between the front seat and the rear seat of the vehicle may occur. Therefore, the front seat and rear seat may be controlled independently of each other.

In the first operational mode, an operation of monitoring whether or not the vehicle occupant is present and the state of the vehicle occupant is performed. To this end, using the vehicle occupancy sensor, as the first sensor, which is provided in the seat of the vehicle, and the internal camera (a ‘first camera’) of the vehicle, it may be recognized whether or not the occupant is present inside the vehicle. In addition, in addition to the first camera, the first sensor may additionally include at least one of the following: the respiratory sensor, the biometric signal detection sensor, or the microphone, each of which is described above, and may monitor the state of the occupant.

In this manner, a step of additionally executing the second operational mode for activating the active noise cancellation (ANC) function equipped in the vehicle and the second sensor and monitoring the movement of the object in the vicinity of the vehicle using the second sensor on the basis of the result of monitoring using the first sensor may be performed (S30).

Specifically, as a result of monitoring using the first sensor, 1) an occupant, 2) the state of the occupant, and 3) the absence of the occupant may be recognized.

First, in a case where the occupant is recognized and where the occupant is in the sleeping state, the second operational mode for keeping the ANC function in the activated state in such a manner as not to disturb the occupant's sleep and monitoring the vicinity of the vehicle to protect the occupant may be executed.

In a case where the occupant is recognized and is not in the sleeping state, the second operational mode is not executed concurrently. However, according to an embodiment, a guide alert that induces or inquires about the execution of the second operational mode after a predetermined time may be output, or door lock control may be performed.

Another example is a case where in the first operational mode, the absence of the occupant is recognized. At this point, in a case where an occupant is not detected within a predetermined time (for example, within five minutes) or within a preset time, the second operational mode may be executed to protect the vehicle. At this point, because an occupant is not present inside the vehicle, only the vicinity of the vehicle may be monitored without activating the ANC function.

As described above, the second operational mode may also be performed on the basis of the user input regardless of whether or not the first operational mode is executed. For example, in a state where the occupant executes the first operational mode, the first operational mode and the second operational mode may also be concurrently executed in a case where an input for executing the second operational mode to monitor the vicinity of the vehicle from inside the vehicle is applied. At this point, an inquire about the activation of the ANC function may be made to the user, and, on the basis of a response to the request, the ANC function may be activated.

Subsequently, in a case where the second operational mode is additionally executed, it may be determined, on the basis of the monitoring by the second sensor, that the object in the vicinity of the vehicle approaches the vehicle (S40).

The second operational mode includes initiating the monitoring of the object in the vicinity of the vehicle and the performing of an intervention operation on the basis of the monitoring result, To this end, using the external camera (the ‘second camera’) of the vehicle, as the second sensor, the object in the vicinity of the vehicle may be recognized, and the behavioral characteristic of the recognized object may be monitored. At this point, in addition to the second camera, at least one of the following, as the second sensor, may be additionally used: the Far Infrared (FIR) camera, the radar/LiDAR, the external microphone, the GPS, or the head/rear lamp.

According to an embodiment, while the second operational mode is executed, a user interface screen, which includes an annotation display (for example, a person, a puppy dog, a cat, or the like) for each moving object in an image acquired through the second camera, may be displayed on the display inside the vehicle or through the registered user terminal.

According to an embodiment, the determination of whether or not the moving object approaches the vehicle may depend on the density of objects in the vicinity of the vehicle. To this end, the image acquired through the second camera may be analyzed, and, concurrently, data associated with the risk level of an area in the vicinity of the vehicle may be received from the cloud server that operates in conjunction with the vehicle monitoring device 800. Thus, a ‘reference’ for determining that an object approaches the vehicle, for example, a threshold distance or a change in behavioral characteristic, each of which serves as a reference, may apply in a varying manner.

For example, in a case where many people move in the vicinity of the vehicle, most of them may simply pass by the vehicle. In this case, although people approach the vehicle within a predetermined distance, it may be determined that they do not truly approach the vehicle. In contrast, in a case where the vehicle is present in a much less frequented location, even when an object that is comparatively remote from the vehicle approaches, it may be determined that the object approaches the vehicle.

In response to the determination that the object in the vicinity of the vehicle approaches the vehicle in this manner, an operation of deactivating the active noise cancellation (ANC) function and outputting an intervention alarm associated with the object's movement may be performed (S50).

Specifically, in a case where an object approaches the vehicle, when an occupant inside the vehicle is either not in the sleeping state or is absent, the intervention alarm may be output in a state where the ANC function is kept in the deactivated state. In contrast, in a case where the vehicle occupant is in the sleeping state, the ANC function is in the activated state. Therefore, the ANC function switches to the deactivated state and then performs an intervention alarm operation in order to record sound outside the vehicle.

The intervention alarm may include recording the monitoring result, checking the door lock, and performing the door lock. For example, in a case where the object in the vicinity of the vehicle approaches the vehicle within the threshold distance or touches the vehicle, the monitoring result may be recorded, and the vehicle may be door-locked without any additional input being applied thereof.

In addition, an output unit for the intervention alarm associated with the object's movement may vary according to whether or not an occupant is recognized. For example, when an occupant is present inside the vehicle, the intervention alarm may be output on the display inside the vehicle. In a case where the occupant is absent inside the vehicle, the registered user terminal may be used as the output unit for the intervention alarm.

According to an embodiment, in the second operational mode, the intervention alarm may vary according to the extent to which the recognized object approaches the vehicle. In addition, the intervention alarm may vary according to the type of the recognized object, the behavioral characteristic of the recognized object, the current location of the vehicle, and the risk level changing over time.

For example, in a case where the object in the vicinity of the vehicle approaches the vehicle within a distance of 5 m, monitoring may be recorded. In a case where the object in the vicinity of the vehicle approaches within a distance of 3 m, the head/rear lamp on the exterior of the vehicle may be controlled to be in a turned-on state, and a warning alert may be output through the external speaker. Moreover, in a case where the object approaches the vehicle very closely and touches it, the vehicle switches to a locking mode. If necessary, the vehicle may perform stepwise intervention operations in such a manner as to autonomously travel to a safety area.

In addition, for example, in a case where the object that approaches the vehicle is a person, visual information indicating approach prohibition may be provided using the window of the vehicle as a display and projected onto the ground using a related technology. In a case where the object that approaches the vehicle is an animal, audio information (for example, the cry of a tiger or similar sound) may be provided, thereby outputting a warning alarm for the approach prohibition. In addition, in a case where the risk level of the current location of the vehicle is high or the current time is nighttime, even when the object approaches within a distance of 3 m, the vehicle may switch to the locking mode and may output a high-level warning alarm.

According to an embodiment, when it is detected by the second sensor that the object approaching the vehicle moves away from the vehicle and a predetermined time has elapsed, the ANC function may switch back to the activated state on the basis of the result of the monitoring by the first sensor.

For example, if the occupant remains in the sleeping state while the object approaching the vehicle moves away from the vehicle, the ANC function may be activated when a predetermined time has elapsed after the object moved away, thereby helping the occupant fall into a deep sleep. However, even in this case, information indicating that the object approaches the vehicle while the occupant remains in the sleeping state is stored and recorded.

FIG. 11 is a block diagram illustrating an exemplary configuration of the vehicle monitoring device 800 in accordance with an embodiment of the present disclosure.

With reference to FIG. 11, the vehicle monitoring device 800 according to the present disclosure may include an interface unit 810, a processor 820, a communication module 830, and an input module 840.

The vehicle monitoring device 800 may receive an input signal/data from vehicular components 1100, for example, a multiplicity of cameras or sensors that are provided in the vehicle, through the interface unit 810. The vehicle monitoring device 800 may transmit an output signal/data to an output unit or the main controller that is provided in the vehicle.

The vehicle monitoring device 800 may communicate with an external service module 1120, such as the eCall, the cloud server, and the user terminal, through the communication module 830. Thus, the vehicle monitoring device 800 may receive information associated with a risk level of the vicinity of the vehicle and may transmit the result of monitoring the interior and surroundings of the vehicle and the intervention alarm.

In the state where the vehicle is parked or stopped, in response to a preset user input received through the input module 840, the processor 820 of the vehicle monitoring device 800 may activate an internal air-conditioning system of the vehicle and the first sensor. Furthermore, the processor 820 may generate a first control signal for monitoring the state of the vehicle occupant using the first sensor and may transmit the generated first control signal to the vehicle 100/the vehicular component 1100 through the interface unit 810.

The processor 820 of the vehicle monitoring device 800 may receive the result of the monitoring by the first sensor through the interface unit 810. The processor 820 may activate the ANC function equipped in the vehicle and the second sensor on the basis of the received result. The processor 820 may generate a second control signal for monitoring the movement of the object in the vicinity of the vehicle using the second sensor and may transmit the generated second control signal to the vehicle 100/the vehicular component 1100 through the interface unit 810.

The processor 820 of the vehicle monitoring device 800 may receive the result of the monitoring by the second sensor and may determine on the basis of the received result that the object approaches the vehicle. In addition, the processor 820 may transmit a third control signal for deactivating the active noise cancellation (ANC) function and outputting an intervention alert associated with the movement of the recognized object on the basis of this determination, to the vehicle 100/the vehicular component 1100 through the interface unit 810.

The second operational mode for monitoring the vicinity of the vehicle may be additionally executed in a state where the first operational mode is executed, and may be executed in a manner that is modified according to the result of monitoring in the first operational mode.

Specifically, when it is determined, in the first operational mode, that the result of the monitoring by the first sensor indicates that the occupant is in the ‘sleeping state,’ the processor 820 of the vehicle monitoring device 800 executes the second operational mode by activating the ANC function and the second sensor. In contrast, when it is determined, as a result of the monitoring by the first sensor, that the occupant is in an absent state for a predetermined time, only the second operational mode is executed by activating only the second sensor.

In the first operational mode, when the result of the monitoring by the first sensor indicates that an occupant is present and the occupant is not in the sleeping state, the processor 820 of the vehicle monitoring device 800 may inquire about the execution of the second operational mode and, on the basis of a response (for example, the user input) to the inquiry, may concurrently execute the second operational mode. At this point, on the basis of the response (for example, the user input) to the inquiry, the occupant may also terminate the first operational mode and execute only the second operational mode.

In still another embodiment, in the first operational mode, the processor 820 of the vehicle monitoring device 800 may induce the second operational mode when the result of the monitoring by the first sensor indicates that an occupant is present and the occupant is not in the sleeping state, and when it is determined that a situational condition acquiring monitoring of the surroundings of the vehicle is satisfied.

At this point, the situational condition requiring the monitoring of the surroundings of the vehicle may be associated with the current location of the vehicle and the current time. For example, guide voice inducing the second operational mode may be output through the internal speaker of the vehicle when the current location of the vehicle, which is identified by the GPS sensor, is a less frequented location and when the current time is late at night.

When the second operational mode is executed, the processor 820 of the vehicle monitoring device 800 may receive risk-level history information for setting an intervention policy corresponding to the risk level of the vicinity of the vehicle by communicating with the external service module 1120 through the communication module 830. The processor 820 may apply an intervention operation corresponding to changes in type and behavioral characteristic of the recognized object in a variable manner on the basis of the received risk-level history information.

According to an embodiment, the intervention policy corresponding to the risk level of the vicinity of the vehicle may be updated at predetermined time intervals (for example, three to four hours). In addition, the behavioral characteristic of the object in the vicinity of the vehicle may be updated at time intervals shorter than the predetermined time intervals.

In a case where, as a result of monitoring in the second operational mode, it is determined that the object in the vicinity of the vehicle approaches the vehicle, the processor 820 of the vehicle monitoring device 800 may perform a differentiated intervention operation on the basis of the direction in which the object moves and the extent to which the object approaches the vehicle.

At this point, the intervention operation may vary according to the result of monitoring in the first operational mode. For example, when an occupant is absent inside the vehicle, a warning alarm may be output through an external output unit of the vehicle, as the intervention operation, and when an occupant is present inside the vehicle, a warning alarm may be output through the internal output unit. When the occupant inside the vehicle is in the sleeping state, before an emergency situation occurs, a warning alarm may be displayed on the internal display of the vehicle in a form of visual information, such as an image.

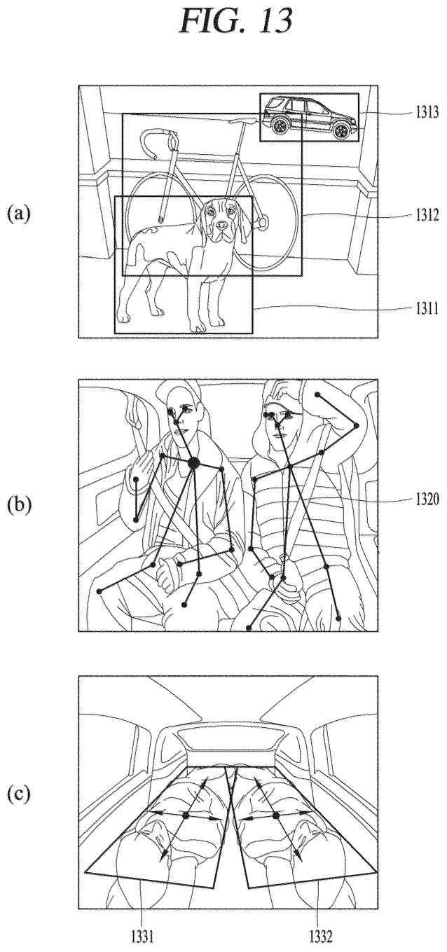

FIGS. 12 and 13 are views that are referenced to describe a method of monitoring the state of the vehicle occupant in the first operational mode described above.

In the first operational mode, whether or not an occupant is present inside the vehicle may be detected, and the number of the detected occupants may be counted. In the first operational mode, an attempt may be made to measure a biometric signal for each occupant, and guide outputting or automatic control, each of which is associated with adjustments to a vehicular air-conditioning system, such as cooling, warming, and air cleaning, may be performed.

FIG. 12 illustrates the flow of specific operations in the first operational mode for monitoring the state of the vehicle occupant, which is described above. Unless otherwise described, the steps of the operation method illustrated in FIG. 12 may be performed by the main controller or the processor of the vehicle, or the processor of the vehicle monitoring device.

With reference to FIG. 12, the method starts with a step of collecting images of the interior of the cabin in real time/at predetermined time intervals for a predetermined time through the internal camera of the vehicle (S21). At this point, the internal camera of the vehicle, that is, the first camera may be installed in a position in which the front and rear seats of the vehicle fall within the camera's field of view. Alternatively, the internal cameras, that is, the first cameras may be installed on the front and rear seats, respectively. The image of the interior of the cabin, which is captured through the first camera, may be an RGB color image or an Infrared (IR) image.

When the images of the interior of the cabin are collected in this manner, the occupant of the vehicle is recognized from the collected images using the vehicle monitoring device or a pre-trained model that operates in conjunction with the vehicle (S22).

Specifically, using the pre-trained model that operates in conjunction with the vehicle, whether or not an object included in the collected image is a person (for example, a child, an adult, or a male) or an animal (for example, a dog, or a cat) and where the object is located may be detected, thereby recognizing the occupant of the vehicle.

For example, with reference to (a) of FIG. 13, image objects 1311, 1312, and 1313 in the form of boxes are generated and displayed on the basis of each object (for example, a dog, a bicycle, or a vehicle) recognized from the displayed image. Each of the image objects 1311, 1312, and 1313 may be displayed while tracking a moving object, and an identifier (for example, the name of the object) identifying the object recognized through the model may be displayed as an annotation in the form of text.

Subsequently, the movement of joint points of the recognized occupant is monitored (S23).

To this end, a model trained in a fine-tuned manner is first selected on the basis of each angle at which the seat is folded, with respect to the image. At this point, this fine-tuning refers to re-training the model by making suitable adjustments for a new purpose based on the pre-trained model that operates in conjunction and finely adjusting the weights of the trained model. In order to select an optimal database on the basis of each angle at which the seat is folded, a plurality of pr-trained models may be used. Then, the estimation of the body pose of an object is performed based on the model trained in a fine-tuned manner.

In this regard, in (b) of FIG. 13, a key point 1320 of the principal joint of each recognized occupant is displayed within the image, and a plurality of key points are recorded in the form of a coordinate arrangement. Then, the history of movement values of the coordinates of the plurality of key points is monitored.

Subsequently, it is determined, by detecting the motion of an occupant, that is, the movement of the joint points, whether or not the occupant is in the sleeping state (S24). Specifically, a movement range corresponding to the history of the coordinates of the key point of the principal joint is compared with a reference range at predetermined time intervals (for example, five to ten seconds) to check whether the movement range falls within the reference range. It is determined, on the basis of the comparison result, whether or not the occupant is in the sleeping state.

For example, as illustrated in (c) of FIG. 13, when a movement range of the key point of the principal joint of the occupant falls within a predetermined range, that is, a sleeping determination range 1331 or 1332 for a predetermined time, it is determined that the occupant is in the sleeping state. Subsequently, in a case where movement out of the sleeping determination range 1331 or 1332 is observed, it is not immediately determined that this movement indicates a wake-up state. Instead, the movement range of the key point of the principal joint may be compared again with the reference range for a predetermined time, and thus the continuous sleeping state/the wake-up state may be determined.

According to an embodiment, in addition to the first camera, the state of the occupant may be recognized through a respiratory sensor inside the vehicle. For example, whether or not an occupant is left alone inside the vehicle, whether the occupant is in the sleeping state or in an abnormal sleeping state, and other similar conditions may be recognized by monitoring characteristics of the occupant, such as the respiratory amplitude, the relative respiratory amplitude, the respiration rate, and the variability of the respiratory rate.

In this manner, on the basis of the result of monitoring the occupant in the first operational mode, the activation of the ANC function inside the vehicle may be determined in a variable manner.

Specifically, when, in the first operational mode, it is determined, as a result of monitoring in the first sensor (for example, the first camera or the respiratory sensor), that the occupant is in the sleeping state, the second operational mode may be executed by activating both the ANC function and the second sensor for monitoring the vicinity of the vehicle through the vehicle monitoring device or the processor of the vehicle.

In addition, when, in the first operational mode, it is determined, as a result of monitoring in the first sensor (for example, the first camera or the respiratory sensor), that the occupant is in the absent state for a predetermined time, the second operational mode may be executed by activating only the second sensor for monitoring the vicinity of the vehicle through the vehicle monitoring device or the processor of the vehicle.

When it is determined in the first operational mode that an occupant is unintentionally left alone inside the vehicle, the vehicular air-conditioning system may be kept in an activated state, and in order to alert that an occupant is left alone, an alarm may be transmitted to the registered user terminal.

According to an embodiment, the monitoring of the state of the occupant, which corresponds to the first operational mode, may continue to be executed even while the monitoring result corresponding to the second operational mode is output. In addition, the result of monitoring in the second operational mode and the intervention operation may be output and performed, respectively, in a manner that is differentiated according to the result of monitoring in the first operational mode.

Specifically, when the result of monitoring in the first operational mode indicates that the occupant is in the sleeping state, the vehicle monitoring device and the processor of the vehicle may output the result of monitoring in the second operational mode, as an intervention alert, through a first output module, for example, a display, which is provided inside the vehicle.

In contrast, when the result of monitoring in the first operational mode indicates that the occupant is in the absent state where the occupant moves away from the vehicle, a vehicle output module may be controlled in such a manner that the result of monitoring in the second operational mode is output, as an intervention alert, through a second output module, for example, an external speaker, a lamp, or a similar component of the vehicle, which is provided on the exterior of the vehicle. In this manner, when the intervention operation is performed, the output unit associated with the result of monitoring in the second operational mode and the intervention operation operates depending on the result of monitoring in the first operational mode.

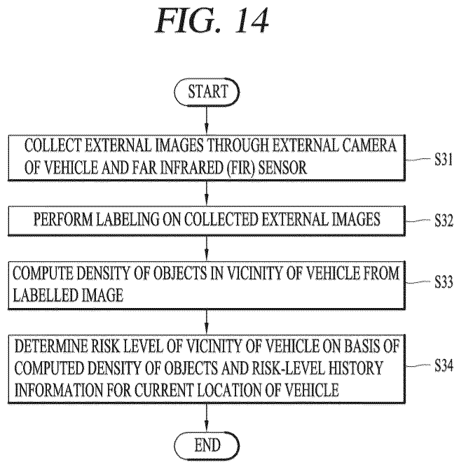

FIG. 14 is a flowchart that illustrates the flow of specific operations in the second operational mode for monitoring the object in the vicinity of the vehicle, which is described above. This flowchart is referenced to describe a method of determining the risk level of the vicinity of the vehicle on the basis of the object in the vicinity of the vehicle.

Unless otherwise described, the steps of the operation method illustrated in FIG. 14 may be performed by the controller or the main processor of the vehicle, or the processor of the vehicle monitoring device.

In the second operational mode described in the present specification, the risk level may be determined in a manner that varies according to the type of the object in the vicinity of the vehicle and the behavioral characteristic of the object, and an intervention most suitable for the determined risk level may be performed. In addition, in a case where the behavioral characteristic of the object changes, the risk level may be correspondingly changed. Accordingly, an intervention different from the previous intervention may be performed, thereby continuously performing a customized intervention suitable for the current situation.

With reference to FIG. 14, by executing the second operational mode, images of the surroundings of the vehicle are continuously collected through the external camera or the Far Infrared (FIR) sensor of the vehicle (S31). A plurality of external cameras of the vehicle may be installed at the front, rear, and/or sides of the vehicle to generate a 3D around view.

Next, a labeling process is performed on the collected images of the surroundings of the vehicle (S32). The labeling process includes performing a semantic segmentation on each collected image. The semantic segmentation refers to a technology that classifies objects from an image using deep learning. Objects in an image may be recognized and classified into stationary objects in the background, such as natural features and buildings, and moving objects using semantic segmentation.

In addition, as another embodiment, after labeling is performed on the external image of the vehicle, information such as the distance or depth of the object in the vicinity of the vehicle may be represented in the form of a point cloud or a depth map that is three-dimensional data.

A process of computing the density of the objects in the vicinity of the vehicle from this labeled image is performed (S33). In the present specification, this process mainly refers to a process of computing the semantic density of dynamic objects because a method of determining the approach of an object in the vicinity of the vehicle to the vehicle and performing an intervention operation is provided. The semantic density of dynamic objects may be acquired by computing the number of pixel labels of dynamic objects as a proportion of the size of the entire image.

The risk level of the vicinity of the vehicle is determined by considering the risk-level history information for the current location of the vehicle, along with the computed density of objects (S34).

Specifically, the processor of the vehicle/the vehicle monitoring device may set an intervention policy on the basis of the determined risk level of the vicinity of the vehicle. At this point, the intervention policy may be set in a manner that varies according to the type, behavioral category, and change in behavioral characteristic of the recognized object, as well as the risk level based on the current time, the current location of the vehicle, and the like.

For example, in a case where the current time is daytime and where the current location of the vehicle is a much frequented location, the risk level may be set to level 1, which is a low-risk level. In addition, in a case where the current time is nighttime and where the current location of the vehicle is a much frequented location, the risk level may be set to level 2. Conversely, in a case where the current time is daytime and where the current location of the vehicle is a less frequented location, the risk level may be set to level 3. In a case where the current time is nighttime and where the vehicle is present in a less frequented location, the risk level may be set to level 4, which is a high risk level.

An intervention policy may be generated in such a manner that, when the risk level is high, a sensitive and severe warning alert is output, and that, when the risk level is low, a more flexible warning alert is issued. At this point, an intervention operation suitable for the intervention policy is downloadable through a cloud server or the like.

In addition, although the risk levels are the same, a technique for outputting a warning alarm may vary according to whether the recognized object is a person or an animal.

In addition, changes in behavioral characteristic of the recognized object may be detected, such as the extent to which the object approaches the vehicle (approach distance or whether or not the object touches the vehicle), an attempt to break into the door or window of the vehicle, crying or knocking on the vehicle, contacting the vehicle using a tool, and similar behaviors. In this case, an intervention policy may be set in such a manner as to output a stronger warning alarm than before or to execute autonomous traveling control using an output unit suitable for the detected behavior.

A weighting value of this risk level may be increased and decreased by receiving the risk-level history information received from the cloud server. The risk-level history information may include, for example, past accumulated evaluations of the risk level by other users on a time-span basis and accumulated accident data.

According to an embodiment, the determined risk level of the vicinity of the vehicle and the intervention policy may be updated at a predetermined period while the second operational mode is executed. For example, although the current location of the vehicle is a less frequented location, the risk level may be lowered when the time span changes after several hours have elapsed. Accordingly, the intervention policy is variably set.

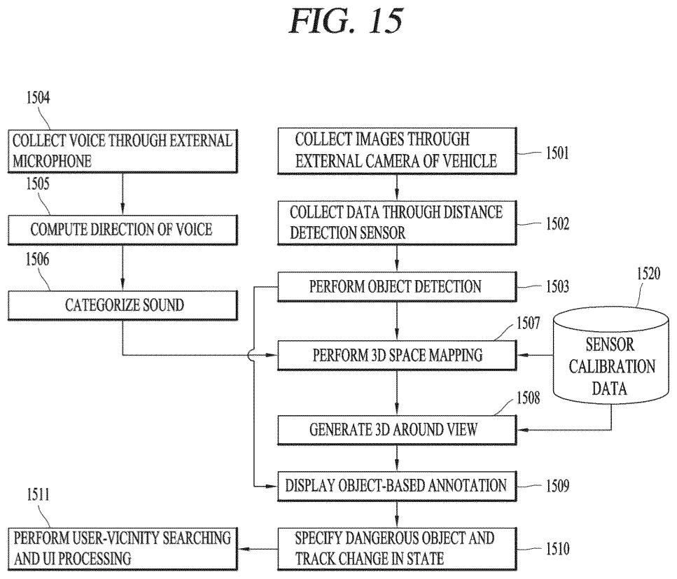

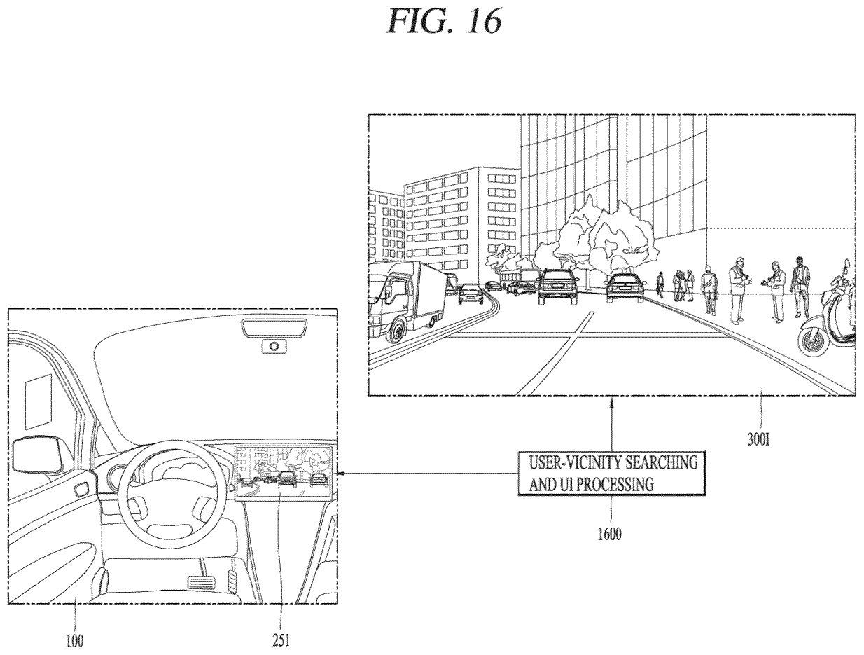

FIGS. 15 and 16 are views that are referenced to describe a process for displaying the result of monitoring the movement of the object in the vicinity of the vehicle on a UI screen in the vehicle in association with the embodiment of the present disclosure.

According to the present disclosure, a user interface (UI) screen may be provided to monitor the vicinity of the vehicle. Through this user interface (UI) screen, the object in the vicinity of the vehicle may be more precisely detected using the external camera, the Far Infrared (FIR) sensor, and the radar/LiDAR, and by extracting sound. Furthermore, detailed information about the recognized object may be checked.

To this end, with reference to FIG. 15, images of the vicinity of the vehicle are continuously collected through the external camera (and the Far Infrared (FIR) sensor) (S1501). Concurrently or sequentially, related data are collected through distance sensors such as the radar or the LiDAR (1502). Therefore, according to the present disclosure, even under situational conditions where an object is difficult to recognize using only the resolution of a camera, the object can be recognized, and it can be detected whether or not the object approaches the vehicle.

Next, an object in the vicinity of the vehicle is detected on the basis of the collected images and the related data (1503). At this point, the detection of the object includes detecting a type of object (for example, a person, an animal, a thing, or the like) and the location of the object.

The detected image-based object is combined with the extracted sound, thereby generating a 3D space map (or ‘3D space matching/mapping’) (1507).

The extraction and combination of the sound for generating the 3D space map are as follows. First, external sound, for example, voice is collected through the external microphone of the vehicle (1504). Then, the direction of the sound is computed on the basis of the collected external sound (1505). At this point, the direction of the sound is computed on the basis of the locations of a plurality of microphones mounted on the exterior of the vehicle.

For example, in a case where the microphones are mounted on the front, sides (for example, one on each of the left and right sides), and rear, respectively, of the vehicle, the direction of the sound may be computed on the basis of the mounting locations of the microphones (for example, those on the rear and left side) that receive the external sound.

Next, the task of classifying the sound may be performed on the basis of the computation of the direction of the sound (1506). For example, the sound that is received by the microphone whose location corresponds to the direction of the sound is noise-filtered and then is transferred to the processor for analysis or compared with data stored in a database operating in conjunction with the vehicle monitoring device 800.

This extracted sound may be categorized by types of sound and sound-emitting objects (for example, dog barking, wolf howling, bear growling, conversation noise, and gunfire). The categorized extracted sound is added to the detected image and thus is combined with an image including the object.

At this point, in a case where a plurality of external cameras are provided on the vehicle, projection mapping and warping, which adjust the pixels of the image, may be performed to generate the 3D space map as a single image. That is, the projection mapping and warping are performed on the generated 3D space map on the basis of the image-based object and the extracted sound, and thus a 3D around view is generated (1508).

While the 3D space mapping (1507) is performed and the 3D around view is generated, sensor calibration data stored in the database operating in conjunction with the vehicle monitoring device 800 may be referred to (1520).

In this generated 3D around view, an annotation is provided in the form of text to every recognized object included in the view (1509). At this point, the annotation may be displayed at a predetermined position (for example, over/under a frame indicating an object recognition range) in the vicinity of the object. The annotation may be displayed while moving to track the movement of the object.

According to an embodiment, a dangerous object may be specified in the 3D around view, and changes in the state of the dangerous object may be continuously tracked (1510).

For example, an annotation on the recognized object categorized as a dangerous object may be displayed, for example, in a visually distinguished manner in a different text font type, color, and size than that on another object to ensure that the annotation on the recognized object is visually distinguished. In addition, for example, in a case where a change in the state of the recognized object categorized as a dangerous object is detected, the change in the state may be more intensively monitored by additionally operating an external sensor of another vehicle or an external camera whose location corresponds to the recognized object.

The 3D around view including the analysis result in this manner includes a user interface UI 1511 capable of receiving the user's selective input and is displayed on the display of the vehicle monitoring device/the vehicle. When the 3D around view including the analysis result is displayed, the user can check detailed information about the result of monitoring the dangerous object using the included user interface UI.

For example, an object of interest may be observed in a magnified manner or tracked, or a predicted behavioral change may be checked on the basis of input into the user interface US 1511.

FIG. 16 schematically illustrates the process of performing vicinity searching and processing 1600 on the monitoring result displayed on the display 251 of the vehicle through input into the user interface UI.

For example, in a case where one or several of all generated 3D around views 3001 are displayed on the display 251, the vicinity searching and processing 1600 is performed on the user input (for example, a drag touch input, a pinch-in/pinch-out touch input, a single/double input, a user voice command, or the like). Accordingly, for example, screen-viewing movement, screen zooming in/out, zooming in on a specific object, and tracking (for example, a movement range over a predetermined time, the number of vehicle approaches, vehicle approach duration, the number of vehicle touches, and the like) may be checked, or a predicted behavior change for each object may be checked.

According to an embodiment, in the second operational mode, in response to receiving input on a specific object or annotation information, each of which is included in the 3D around view output on the display, the processor of the vehicle/the vehicle monitoring device may control the operation of the second sensor and the operation of the output module associated with the operation of the second sensor in such a manner as to track the risk sensitivity to the corresponding object.

For example, in a case where a specific object included in the 3D around view 3001 in FIG. 16 is selected, a control signal may be generated and transferred in such a manner that screen control, such as screen movement, is performed and that the sensor mounted near the location of the corresponding object and the neighboring sensor precisely monitor the corresponding object.

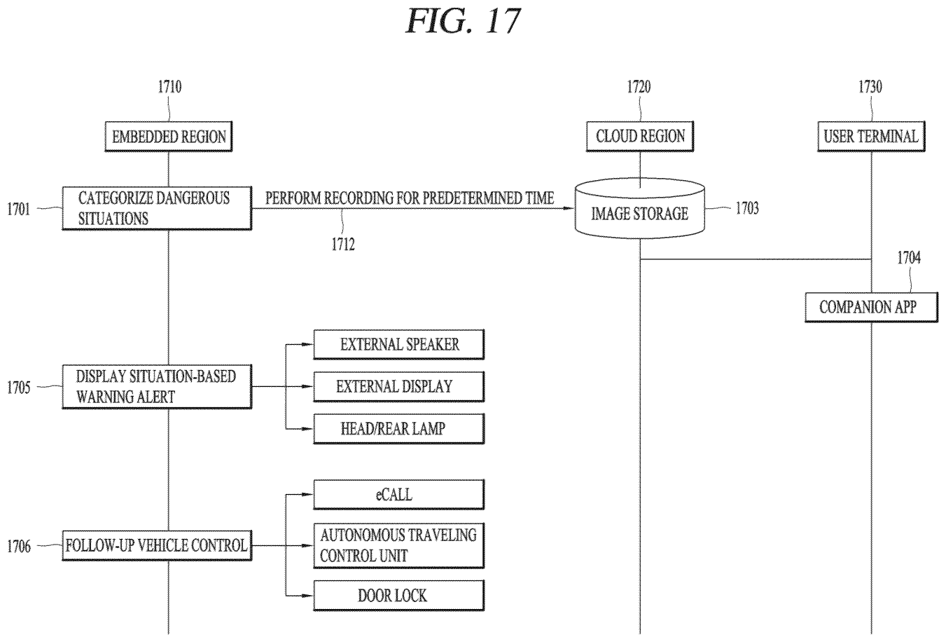

FIGS. 17 to 19 are views illustrating how a situation-based warning alert is output and/or autonomous-traveling control is performed on the basis of the monitoring of the movement of the object in the vicinity of the vehicle in accordance with the embodiment of the present disclosure.

With reference to FIG. 17, a system for performing a situation-based intervention operation on the basis of the monitoring of the movement of the object in the vicinity of the vehicle may broadly include an embedded region 1710, a cloud region 1720, and a user terminal 1730. The embedded region 1710 is associated with the operations of the sensor/the component/the processor embedded in the vehicle. The cloud region 1720 is capable of providing high-volume storage and communicating with the vehicle. The user terminal 1730 is carried by the driver/the occupant.

According to an embodiment, the embedded region 1710 and the cloud region 1720 may selectively operate in conjunction with each other on the basis of the user input.

In a case where the embedded region 1710 and the cloud region 1720 do not operate in conjunction with each other, only the monitoring of the detected object may be performed through a plurality of external cameras provided in the embedded region 1710.

Conversely, in a case where the embedded region 1710 and the cloud region 1720 operate in conjunction with each other, video from the 3D around view, including the result of monitoring the detected object, for example, the analysis result, may be stored and recorded in a designated region.

A case where the embedded region 1710 and the cloud region 1720 operate in conjunction with each other is assumed below for description.

First, dangers in the vicinity of the vehicle are monitored in the embedded region 1710, and dangerous situations are categorized (1701). At this point, an image corresponding to the monitoring of the vehicle may be transferred to the cloud region 1710 at predetermined time intervals and may be stored in image storage 1703. In addition, a user terminal 1730 that operates in conjunction with the vehicle (or that is registered) may have access to the cloud region 1720 through a companion application. After performing processing such as user authentication, the user terminal 1730 may download an image corresponding to the monitoring of the vehicle, which is stored in the image storage 1703 (1704).

The embedded region 1710 may output a situation-based warning alert on the basis of the monitoring result (1705). The warning alert may be provided in an audio/visual form through the external speaker, the external display, and the head/rear lamp of the vehicle.

A suitable output unit corresponding to the location and behavior of the recognized object is selected, and the warning alert is output through the selected suitable output unit. In addition, although the output units that output the warning alert are the same, they may be controlled to operate in a manner that varies according to the behavioral characteristic of the recognized object.

According to an embodiment, the external speaker of the vehicle may acoustically output an alert sound, warning that the recognized object should not approach the vehicle any further. For example, in a case where the recognized object approaches the left side of the vehicle, a low-level alert sound may be output through a speaker mounted on the left side of the vehicle. In addition, for example, in a case where the recognized object touches the door or the window of the vehicle, a higher-level warning alert sound may be output.

According to an embodiment, visual information alerting the recognized object to the operating state of the vehicle may be output, as a warning alert, on the external display of the vehicle. At this point, the visual information may be output on the side window of the vehicle, the front windshield, or the rear window, or may be projected onto the ground.

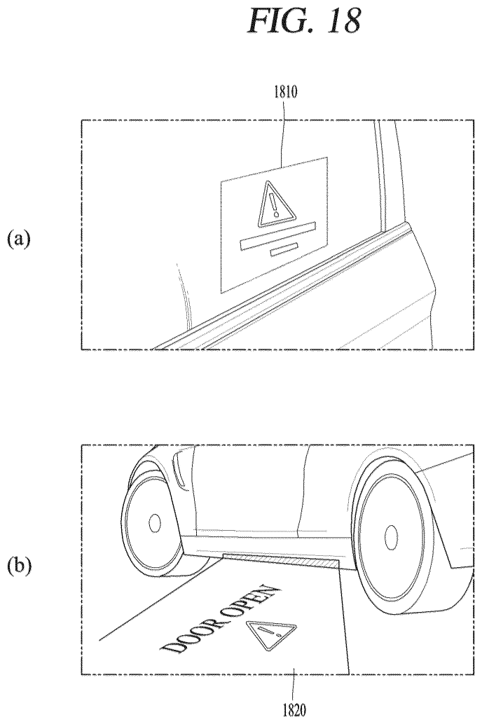

For example, as illustrated in FIG. 18, the external display of the vehicle may operate in such a manner that a warning display 1810 indicating approach prohibition is output on the side window (for example, the left side window/the right side window) that the recognized object approaches (a) or that an alert display 1820 indicating door opening is projected onto the ground near the door of the vehicle that the recognized object approaches (b).

According to an embodiment, the head/rear lamp may be repeatedly turned on and off, thereby providing a warning alert. For example, in a case where the recognized object approaches the front of the vehicle within a threshold distance or repeatedly touches the vehicle, the head lamp of the vehicle may be turned on. Similarly, in a case where the recognized object approaches the rear of the vehicle within a threshold distance or repeatedly touches the vehicle, the rear lamp of the vehicle may be turned on, or the head and rear lamps may be simultaneously turned on.

The head/rear lamp of the vehicle can operate in such a manner that a warning alert is output in a situation where a set illuminance value is not reached.

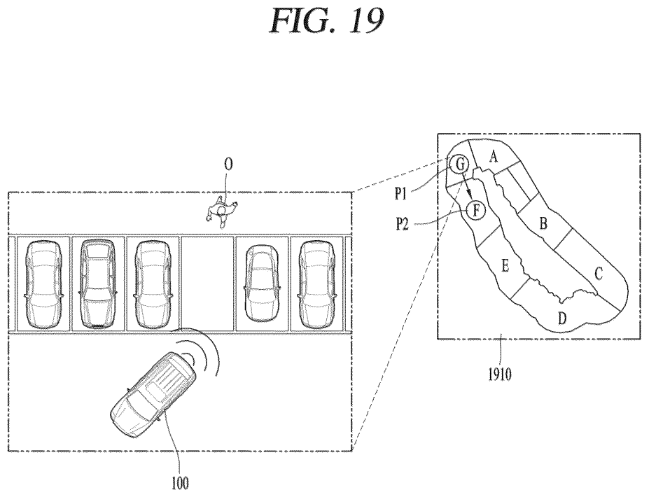

In an emergency situation, the embedded region 1710 may also perform predetermined vehicle control as a follow-up action (1706). Specifically, in an emergency situation, the eCall may be initiated through the telematics and the cloud server, or autonomous traveling control may be executed in such a manner that the vehicle moves to a safe place by transferring a signal to the autonomous traveling control unit. In this case, the safe place close to the current location of the vehicle may be downloaded from the cloud server. Accordingly, as illustrated in FIG. 19, in association with the autonomous traveling control of the vehicle 100, a navigation screen 1910 including an escape location P2 close to the current location P1 of the vehicle may be provided. In addition, for example, if necessary, the door lock may also be performed to prevent breaking into the vehicle.

At least one of the following may be transmitted to the registered user terminal 1730: an explanation of the emergency situation, a request for permission related to vehicle control, or the result of vehicle control.

According to an embodiment, in the second operational mode, the processor of the vehicle/the vehicle monitoring device may variably output an intervention alert that matches the movement of the object while gradually increasing a risk situation level according to the extent to which the object approaches the vehicle.

Specifically, in response to the object approaching the vehicle within a first reference distance range, the processor may output information associated with the object by operating at least one of the following: the display or the audio output part, each of which is provided inside the vehicle. At this point, the information associated with the object may include an image including the object, and intervention guide information related to the object.

In addition, according to an embodiment, in response to the object approaching the vehicle within a second reference distance range shorter than the first reference distance range, the processor may output the intervention alert by operating at least one of the following: the audio output part, the display, or the lamp, each of which is provided on the exterior of the vehicle.

In addition, according to an embodiment, when the object approaches the vehicle within the second reference distance range and then satisfies a preset condition, the processor may generate a control signal for executing a vehicle locking mode and switching to an autonomous traveling mode.

As described above, according to one or several embodiments of the present disclosure, in the state where the vehicle is parked or stopped, the object in the vicinity of the vehicle can be continuously monitored, with the vehicular air-conditioning system and the ANC function remaining operational. Accordingly, a pleasant in-vehicle environment can be provided to the occupant of the vehicle, and the vehicle can be securely protected from an external brake-in. In addition, an optimal adaptive warning alarm and intervention may be provided, taking into account all of the following: the types of objects in the vicinity of the vehicle, the behavioral characteristic of the object, the change in the behavior of the object, and the state or location of the vehicle occupant/the vehicle owner. For example, as a result of monitoring the object in the vicinity of the vehicle, the vehicle occupant can listen to external sound by deactivating the ANC function. In addition, for example, a differentiated alarm can be provided according to the extent to which a dangerous object approaches the vehicle. Based on the state or location of the occupant/the vehicle owner, warning alarms at stepwise levels can be provided, or a warning output unit can be selectively used. In addition, for example, in a state where the door of the vehicle is open or in a situation where the vehicle owner is present in the vicinity of the vehicle, but does not pay attention to the vehicle, the vehicle can still be securely protected from external risks.

The present disclosure can be implemented as computer-readable codes (applications or software) in a program-recorded medium. The control method of the autonomous vehicle described above can be implemented using codes stored in memory, etc.

The computer-readable medium may include all types of recording devices each storing data readable by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). Also, the computer may include a processor or a controller. Therefore, the detailed description should not be limitedly construed in all of the aspects, and should be understood to be illustrative. The scope of the present disclosure should be determined by reasonable interpretation of the appended claims, and all changes within the equivalent scope of the present disclosure are embraced by the appended claims.

1. A vehicle comprising:
a first sensor that is provided inside the vehicle and monitors a state of a vehicle occupant;
a second sensor that is provided on the exterior of the vehicle and monitors the movement of an object in the vicinity of the vehicle;
a noise control module that controls the operation of an adaptive noise cancellation (ANC) function equipped in the vehicle;
output modules that are provided inside the vehicle and on the exterior of the vehicle, respectively; and
a processor that executes a first operational mode for activating an internal air-conditioning system of the vehicle and the first sensor on the basis of a received user input in a state where the vehicle is parked or stopped, and that, in the first operational mode, on the basis of the result of the monitoring by the first sensor, additionally executes a second operational mode for activating the adaptive noise cancellation (ANC) function and the second sensor,
wherein the processor determines on the basis of the monitoring by the second sensor that the object in the vicinity of the vehicle approaches the vehicle, and controls the noise control module and the output modules on the basis of the determination in such a manner as to deactivate the adaptive noise cancellation (ANC) function and to output an intervention alert associated with the movement of the object.

2. The vehicle of claim 1, wherein, in the first operational mode, the processor executes the second operational mode by activating both the ANC function and the second sensor when it is determined as a result of monitoring by the first sensor that an occupant is in a sleeping state, and executes the second operational mode by activating the second sensor when it is determined as a result of monitoring by the first sensor that the occupant is in an absent state for a predetermined time.

3. The vehicle of claim 2, wherein the first sensor is an internal camera of the vehicle, and
wherein the processor recognizes the occupant from images collected through the internal camera using a pre-trained model operating in conjunction with the processor, and determines whether or not the occupant is in the sleeping state by detecting the movement of joint points of the recognized occupant.

4. The vehicle of claim 2, wherein the processor controls the output modules in such a manner that the intervention alert is output through a first output module provided inside the vehicle when the occupant is in the sleeping state, and that the intervention alert is output through a second output module provided on the exterior of the vehicle when the occupant is in the absent state.

5. The vehicle of claim 1, wherein the second sensor includes an external camera and a Far Infrared (FAR) sensor of the vehicle, and
wherein, when the second operational mode starts, the processor performs labeling on images collected through the external camera and the Far Infrared (FAR) sensor, computes the density of the objects from the labeled images, and determines a risk level of the vicinity of the vehicle on the basis of the computed density of the objects and risk-level history information for the current location of the vehicle.

6. The vehicle of claim 5, wherein the processor sets an intervention policy corresponding to the intervention alert on the basis of the risk level of the vicinity of the vehicle, and
wherein the intervention policy is set in a manner that varies according to the time, the location, the type of the object, and the behavioral category of the object.

7. The vehicle of claim 6, wherein the risk level of the vicinity of the vehicle and the intervention policy are updated at a predetermined period while the second operational mode is executed.

8. The vehicle of claim 1, wherein the processor outputs the intervention alert that matches the movement of the object while gradually increasing a risk situation level according to the extent to which the object approaches the vehicle.

9. The vehicle of claim 8, wherein in response to the object approaching the vehicle within a first reference distance range, the processor outputs information associated with the object by operating at least one of the following: a display and an audio output part, which are provided in the vehicle, and in response to the object approaching the vehicle within a second reference distance range shorter than the first reference distance range, the processor outputs the intervention alert by operating at least one of the following: the audio output part, the display, or a lamp, each of which is provided on the exterior of the vehicle.

10. The vehicle of claim 9, wherein information associated with the object includes an image including the object and intervention guide information related to the object.

11. The vehicle of claim 9, wherein, when the object approaches the vehicle within the second reference distance range and then satisfies a preset condition, the processor generates a control signal for executing a vehicle locking mode and switching to an autonomous traveling mode.

12. The vehicle of claim 1, wherein, while the second operational mode is executed, the processor controls the output modules in such a manner that the direction of sound collected through a microphone provided on the exterior of the vehicle is tracked, that a 3D view of an image, including the object in the vicinity of the vehicle, which is collected by the second sensor, is generated on the basis of the tracking, and that the image from the generated 3D view is output, as the intervention alert, on a display inside the vehicle.

13. The vehicle of claim 12, wherein the image from the 3D view includes annotation information for each recognized object and an identification display for the object that approaches the vehicle.

14. The vehicle of claim 13, wherein, in response to receiving input on a specific object or the annotation information, each of which is included in the image from the 3D view, which is output on the display, the processor controls the operation of the second sensor and the operation of the output modules associated with the operation of the second sensor in such a manner as to track the risk sensitivity to the corresponding object.

15. The vehicle of claim 1, wherein, when it is detected by the second sensor that the corresponding object moves away from the vehicle and a predetermined time has elapsed, the processor controls the noise control module on the basis of the monitoring by the first sensor in such a manner that the ANC function is reactivated.

16. A method of operating a vehicle, the method comprising:
a step of receiving, by a processor provided in the vehicle, a preset user input in a state where the vehicle is parked or stopped;
a step of executing a first operational mode for activating an internal air-conditioning system of the vehicle and a first sensor and monitoring a state of a vehicle occupant using the first sensor, on the basis of the received user input;
a step of additionally executing a second operational mode for activating an adaptive noise cancellation (ANC) function equipped in the vehicle and a second sensor and monitoring the movement of an object in the vicinity of the vehicle using the second sensor, on the basis of the result of the monitoring by the first sensor in the first operational mode;
a step of determining on the basis of the monitoring by the second sensor that the object in the vicinity of the vehicle approaches the vehicle; and
a step of deactivating the adaptive noise cancellation (ANC) function and outputting an intervention alert associated with the movement of the object, on the basis of the determination

17. The method of claim 16, further comprising, after the step of executing the first operational mode:
a step of executing the second operational mode by activating both the ANC function and the second sensor when it is determined as a result of monitoring by the first sensor that the occupant is in a sleeping state, and
activating the second sensor by executing the second operational mode when it is determined as a result of monitoring by the first sensor that the occupant is in an absent state for a predetermined time.

18. The method of claim 17, wherein the step of outputting the intervention alert is a step of outputting the intervention alert through a first output module provided inside the vehicle when the occupant is in the sleeping state and outputting the intervention alert through a second output module provided on the exterior of the vehicle when the occupant is in the absent state.

19. The method of claim 16, wherein the step of outputting the intervention alert is a step of outputting the intervention alert that matches the movement of the object while gradually increasing a risk situation level according to the extent to which the object in the vicinity of the vehicle approaches the vehicle.

20. A vehicle monitoring device comprising:
an interface unit that performs communication with at least one of the components provided in a vehicle; and
a processor that, in a state where the vehicle is parked or stopped, in response to reception of a signal corresponding to a preset user input, generates a first control signal for activating an internal air-conditioning system of the vehicle and a first sensor and monitoring a state of a vehicle occupant using the first sensor and transmits the generated first control signal to the vehicle through the interface unit,
wherein the processor generates a second control signal for receiving the result of the monitoring by the first sensor, activating an adaptive noise cancellation (ANC) function equipped in the vehicle and a second sensor on the basis of the received result, and monitoring the movement of an object in the vicinity of the vehicle using the second sensor, and transmits the generated second control signal to the vehicle through the interface unit, and
wherein the processor transmits a third control signal for receiving the result of the monitoring by the second sensor, determining on the basis of the received result that the object approaches the vehicle, deactivating the active noise cancellation (ANC) function on the basis of the determination, and outputting an intervention alert associated with the movement of the object, to the vehicle through the interface unit.
